(19) United States
(12) Patent Application Publication
(10) Pub. No.: US 2026/0121857 A1
(43) Pub. Date: Apr. 30, 2026

(54) METHODS AND SYSTEMS FOR QUANTUM-AUTHENTICATED DIGITAL TOKEN GENERATION

(71) Applicant: Maher A Abdelsamie, Bronx, NY (US)

(72) Inventor: Maher A Abdelsamie, Bronx, NY (US)

(21) Appl. No.: 19/241,192

(22) Filed: Jun. 17, 2025

Related U.S. Application Data
(60) Provisional application No. 63/742,712, filed on Jan. 7, 2025.
(60) Provisional application No. 63/752,788, filed on Feb. 2, 2025.

(51) Int. Cl. H04L 9/32; H04L 9/08

(52) U.S. Cl. CPC H04L 9/3213; H04L 9/0852

(57) ABSTRACT

A quantum-authenticated digital token generation system comprises a classical computing device with parameter calculation and verification modules, and a quantum computing device with control devices, connected via an exchange interface. The system enforces quantum mechanical speed limits by calculating minimum evolution times based on energy uncertainty from quantum hardware characteristics. Quantum hardware execution is verified through quantum state overlap analysis, entropy measurements, and noise signature verification. The system implements quantum hardware fingerprinting using device-specific calibration data including qubit frequencies and decoherence times. Echo revival protocols employ time-reversed quantum circuits to verify quantum coherence maintenance, distinguishing genuine quantum operations from classical simulation. Multi-modal verification combines quantum mechanical constraints, hardware attestation, and cryptographic commitments with temporal anti-precomputation mechanisms. The system integrates with blockchain networks through transaction assembly modules, providing quantum-enhanced security for digital tokens.

### TECHNICAL FIELD

The present invention relates generally to quantum computing systems and distributed ledger technologies. More particularly, the invention may relate to quantum-secured distributed ledger systems and methods for quantum-state-authenticated digital token generation and validation.

### BACKGROUND

Conventional blockchain systems may rely on classical cryptographic primitives and consensus mechanisms that may be vulnerable to various attack vectors including but not limited to simulation attacks, replay attacks, and pre-computation attacks. Traditional blockchain security may depend primarily on computational hardness assumptions rather than fundamental physical constraints, which may limit long-term security guarantees particularly in the presence of advancing quantum computing capabilities.

Existing quantum money proposals and quantum cryptographic protocols may utilize quantum states for security purposes but may lack integration with practical blockchain infrastructure. Such systems may not address critical challenges including verifiable quantum hardware authenticity, real-time quantum execution verification, and protection against device operator collusion in distributed computing environments.

Current quantum blockchain proposals may focus primarily on post-quantum cryptography or theoretical quantum money implementations but may not provide mechanisms for physically binding block validation to real-time quantum execution on verified quantum hardware. These approaches may fail to prevent pre-computation attacks wherein adversaries may simulate or pre-calculate quantum results before blockchain parameters may be determined.

Conventional systems may be unable to distinguish genuine quantum computation from classical simulation, particularly in cloud-based quantum computing environments where device operators may potentially collude with malicious users. Existing verification protocols may lack the capability to automatically detect and reject simulated, replayed, or manipulated quantum computation results.

Furthermore, traditional blockchain consensus mechanisms may not incorporate quantum hardware attestation or device-specific calibration verification, creating vulnerabilities wherein fake quantum proofs may be accepted if they may appear statistically consistent with quantum noise characteristics.

There exists a need for quantum-enhanced blockchain systems that may provide secure and trustless quantum proof-of-execution capabilities, wherein only genuine quantum computation performed on verified quantum hardware may generate valid cryptographic proofs for blockchain validation. Additionally, there exists a need for protection against device and operator collusion, wherein quantum device providers may be prevented from colluding with dishonest users to produce fake proofs or manipulate quantum execution results. Systems may require verifiable quantum hardware authenticity mechanisms that may guarantee results originate from specific, genuine quantum devices rather than simulators, emulators, or manipulated data sources. Consequently, there is a pressing need for innovative solutions to overcome these limitations.

### SUMMARY

The present invention relates to methods and systems for quantum-state-verified digital token generation and blockchain validation. A quantum computing system 202 comprises a classical computing device (102) comprising a parameter calculation and optimization module (104) configured to compute quantum circuit parameters including phase angles derived from a cryptographically unpredictable source associated with a transaction or block, a feedback control module (110) configured to apply real-time adjustments to system parameters for quantum state preparation, a measurement analysis and feedback module (108) configured to analyze quantum measurement outcomes for state overlap, entropy, and coherence metrics, an error correction manager (106) configured to adaptively perform error correction based on measured error syndromes, a transaction assembly module (120) configured to assemble transaction data and associated quantum proofs, a verification module (122) configured to verify quantum proofs of execution, noise signatures, and hardware attestation, and an off-chain storage module (124) configured to store quantum proof data and calibration records.

The quantum computing system 202 further comprises a quantum computing device (112) comprising control devices (114) configured to receive instructions and apply quantum gates and entanglement operations, and a quantum system (116) configured to execute quantum circuits comprising blockhash-dependent or transaction-dependent parameterizations. The quantum computing system 202 further comprises an exchange interface (118) facilitates bidirectional communication between the classical computing device (102) and the quantum computing device (112).

In one or more embodiments, the quantum computing system 202 may calibrate the quantum system (116) to extract device-specific calibration parameters including but not limited to energy deltas or qubit frequencies, may generate quantum circuits having one or more phase angles determined from cryptographically unpredictable values associated with transactions or blocks, may execute quantum circuits and receive quantum measurement outcomes, may perform echo or time-reversal circuits to verify quantum coherence via revival probability, may analyze measurement outcomes for noise, entropy, or diversity signatures indicative of genuine quantum hardware execution, may cryptographically sign and associate digital proofs with transactions or blocks, may reject simulated, replayed, or pre-computed proofs by verifying block-specific phase personalization and coherence revival, and may record cryptographically signed quantum proofs in distributed ledgers or blockchains.

The invention comprises a method for generating and verifying quantum-state-based digital tokens in a blockchain. In one or more embodiments, the method may comprise generating, using a classical computing device (102), challenges comprising blockhash- or transaction-dependent parameters including quantum circuit phase angles derived from cryptographically unpredictable sources, communicating challenges to quantum computing devices (112) via exchange interfaces (118), executing, on quantum computing devices (112), quantum circuits parameterized by challenges to obtain quantum measurement outcomes, executing echo or time-reversed quantum circuits to test quantum coherence via state revival probability, returning quantum measurement outcomes to classical computing devices (102), analyzing quantum measurement outcomes for quantum noise, entropy, and coherence metrics to verify genuine quantum hardware execution, binding quantum proofs to challenges and cryptographically signing proofs, recording signed proofs in blockchains such that each proof is uniquely associated with specific transactions or blocks, and rejecting quantum proofs that fail phase personalization, echo coherence verification, hardware attestation, entropy or noise analysis, or cryptographic signature validation.

In one or more embodiments, the parameter calculation and optimization module (104) may calculate energy uncertainty values and may derive quantum circuit phase angles from cryptographically unpredictable values that may be selected from the group consisting of blockhashes, transaction hashes, random nonces, or cryptographic commitments.

In one or more embodiments, the feedback control module (110) may apply real-time adjustments to quantum circuit parameters that may be based on device calibration updates, performance metrics, and environmental conditions.

In one or more embodiments, the measurement analysis and feedback module (108) may extract counts from quantum measurement results, may convert measurement outcomes to standardized bit string formats, and may perform statistical analysis of measurement distributions.

In one or more embodiments, the error correction manager (106) may apply transpilation optimization to quantum circuits and may implement adaptive error correction strategies. In one or more embodiments, the transaction assembly module (120) may create blockchain transactions that may incorporate quantum proof data as transaction metadata and may bundle quantum proofs with transactions for consensus inclusion.

In one or more embodiments, the verification module (122) may implement defense-in-depth security by requiring successful verification across multiple verification layers that may include but not limited to quantum state overlap verification, noise signature verification, timing constraint verification, and blockchain commitment verification.

In one or more embodiments, the off-chain storage module (124) may store quantum measurement data, device calibration parameters, verification logs, and blockchain metadata in databases that may be selected from the group consisting of relational databases, key-value stores, or distributed ledgers.

In one or more embodiments, the exchange interface (118) may transmit quantum circuit instructions, may receive measurement results, and may provide real-time control updates for gate parameterization between classical and quantum computing devices.

In one or more embodiments, quantum circuits may comprise envelope protection mechanism layers that may comprise sequences of quantum gate operations that may be determined by parameterizable security settings that may include decay rates, phase factors, layer multipliers, minimum layers, basis rotation settings, and alignment angles.

In one or more embodiments, envelope protection mechanism evolution operators may be applied in forward and time-reversed configurations to create echo verification circuits for quantum coherence testing.

In one or more embodiments, quantum circuits may comprise main circuits and echo circuits, wherein echo circuits may apply time-reversed evolution operators to verify quantum coherence maintenance and may achieve return probabilities to initial quantum states that may exceed predetermined thresholds.

In one or more embodiments, quantum circuits may incorporate blockhash-dependent phase encoding using deterministic derivation of phase angles from blockchain hash values that may be applied through configurable cryptographic hash (e.g., default SHA-3-256, alternative SHA-512/256, BLAKE3, etc.) to concatenated blockhash and qubit index values. In one or more embodiments, quantum circuits may comprise sequences of Hadamard gates for superposition creation, rotation gates (Rz, Rx) for phase encoding, and controlled-Z (CZ) gates for entanglement generation.

In one or more embodiments, the system may generate blind challenge phases such that quantum devices may not determine challenge parameters until after circuit commitment and recording. In one or more embodiments, quantum state overlap verification may comprise calculating experimental overlap values from measurement counts and may compare with theoretical overlap values.

In one or more embodiments, noise signature verification may comprise analyzing entropy and diversity metrics of measurement count distributions with predetermined threshold ranges for authentic quantum noise detection. In one or more embodiments, timing constraint verification may comprise comparing execution timestamps with deadline values that may be specified in blind challenges and may reject proofs exceeding predetermined time windows. In one or more embodiments, blockchain commitment verification may comprise comparing computed commitment hashes with stored commitment values using cryptographic hash functions and HMAC operations with master keys.

In one or more embodiments, the verification module (122) may implement one or more machine learning algorithms for adaptive threshold adjustment of noise, entropy, or overlap metrics and may implement optimization techniques for verification parameter refinement.

In one or more embodiments, the system may implement exponentially scalable security through time-step parameters that may control quantum circuit complexity such that security may scale as O(2\hat{ }(TIME_STEPS×N_QUBITS×256)) while verification may remain polynomial in time-step parameters. In one or more embodiments, the system may implement temporal anti-precomputation mechanisms by generating cryptographic commitments before blockchain mining may reveal quantum circuit parameters, wherein temporal separation between commitment and parameter revelation may prevent storage-based precomputation attacks.

In one or more embodiments, phase tweaks may be generated using HMAC operations with master keys, challenge nonces, qubit indices, and/or note identifiers as inputs to ensure information-theoretic security against device operator collusion. In one or more embodiments, the system may implement automatic security scaling by adjusting time-step parameters that may be based on detected attack capabilities, security requirements, or quantum hardware evolution. In one or more embodiments, the system may implement validator slashing, jailing, or removal mechanisms in response to validator misbehavior, wherein slashing penalties may be applied to staked tokens that may be based on quantum proof verification failures.

In one or more embodiments, the classical computing device (102) may communicate with user devices (206) over networks (204) to provide quantum-verified digital token services, wherein users (208) may request quantum verification services for digital asset transfers, smart contract execution, or identity authentication. In one or more embodiments, quantum proofs may include hardware attestation strings that may comprise quantum device backend names, calibration timestamps, quantum job identifiers, and device-specific calibration parameters that may be cryptographically bound to quantum proof data. In one or more embodiments, the system may operate with quantum computing devices of different technologies that may include superconducting qubits, trapped ions, or photonic systems.

In one or more embodiments, generating challenges may comprise computing phase angles as hashes of blockhashes and qubit indices, and executing quantum circuits may comprise superposition steps, blockhash-dependent phase tagging steps, and envelope protection mechanism layers. In one or more embodiments, the method may include analyzing quantum measurement outcomes to compute overlap between expected and measured states, may compute Shannon entropy or diversity of quantum measurement outcomes, and may reject proofs if overlap errors exceed predetermined thresholds or entropy falls outside quantum hardware-expected ranges.

In one or more embodiments, the method may include calibrating quantum computing devices prior to execution to extract device-specific parameters that may include energy deltas or qubit frequencies, and may record hardware attestation strings that may include device calibration parameters. In one or more embodiments, challenges may be communicated to multiple quantum computing devices and quantum proofs may be cross-validated among different devices for security verification.

In one or more embodiments, the method may include assembling transactions that may include quantum proofs and may submit transactions to distributed ledgers or blockchains, and may reject proofs if execution timestamps exceed predetermined deadlines that may be associated with challenge commitments.

In one or more embodiments, the system may provide application programming interfaces that may enable third-party integration of quantum verification services into existing blockchain applications or distributed systems. In one or more embodiments, the verification module (122) may implement forensic analysis capabilities for post-incident investigation of quantum security breaches or verification failures.

In one or more embodiments, quantum circuit parameters or cryptographic signature schemes may be selected based on configurable policies, protocol parameters, or upgradeable governance decisions. In one or more embodiments, the blockchain may comprise public, permissionless, or consortium ledger configurations and quantum computing devices may be physically separate from or integrated with classical computing devices.

In one or more embodiments, the system may implement circuit hash verification using quantum circuit serialization techniques to ensure circuit integrity and may prevent tampering during transmission or storage. In one or more embodiments, the measurement analysis and feedback module (108) may implement statistical analysis of measurement distributions to detect deviations that may be indicative of classical simulation or hardware manipulation.

In one or more embodiments, the system may implement adaptive echo revival threshold adjustment that may be based on quantum hardware characteristics and environmental noise conditions. In one or more embodiments, the parameter calculation and optimization module (104) may implement dynamic security parameter scaling that may be based on computational threat assessments and quantum hardware capabilities. In one or more embodiments, the system may implement multi-modal verification redundancy such that failure of individual verification layers may not compromise overall security guarantees.

Various embodiments of the present invention are provided in the following detailed description and appended drawings. Without departing from the present invention, several details of the present invention may be capable of modifications in various respects, and the present invention is capable of various embodiments. Accordingly, the description and appended drawings of the present invention are provided as illustrations only, and they do not limit or define the scope of the invention being defined by the appended claims.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference may be made to the following detailed description, which is to be read in association with the accompanying drawings:

FIG. 1 is a block diagram illustrating an example quantum computing system architecture in accordance with one or more embodiments;

FIG. 2 is a simplified network diagram illustrating system participants and communication infrastructure for a quantum-authenticated digital-token generation and verification in accordance with one or more embodiments;

FIG. 3 is a simplified flowchart illustrating an exemplary process flow for generating and verifying quantum-authenticated digital tokens in accordance with one or more embodiments; and

FIG. 4 is a block diagram illustrating example components of the classical computing device 102 as shown in FIG. 1 and FIG. 2.

The headings used herein are not meant to be used to limit the scope of the claims or description. The headings used herein are for organizational purposes only. To facilitate understanding, like reference numerals have been used, where possible, to designate like elements common to the figures.

### DETAILED DESCRIPTION

The presently disclosed subject matter is described with specificity to meet statutory requirements. However, the description itself is not intended to limit the scope of this patent. Moreover, although the term “step” may be used herein to connote different aspects of methods employed, the term should not be interpreted as implying any particular order among or between various steps herein disclosed unless and except when the order of individual steps is explicitly described.

Reference throughout this specification to “one embodiment” or “an embodiment” means that a particular feature, structure, or characteristic described in connection with the embodiment is included in at least one embodiment of the disclosed subject matter. Thus, appearances of the phrases “in one embodiment” or “in an embodiment” in various places throughout this specification are not necessarily referring to the same embodiment.

As used in this specification and the appended claims, the singular forms “a,” “an,” and “the” include or otherwise refer to singular as well as plural referents, unless the content clearly dictates otherwise. As used in this specification and the appended claims, the term “or” is generally employed to include “and/or,” unless the content clearly dictates otherwise.

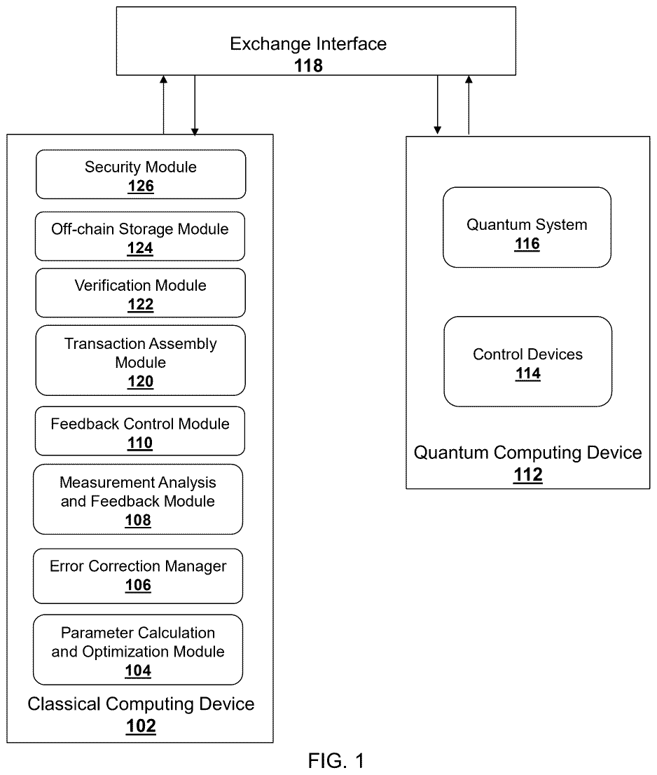

FIG. 1 illustrates an example quantum computing system architecture in accordance with one or more embodiments.

The quantum computing system may comprise a classical computing device 102 and a quantum computing device 112, which may communicate through an exchange interface 118. The classical computing device 102 may comprise one or more modules including a feedback control module 110, a measurement analysis and feedback module 108, an error correction manager 106, a parameter calculation and optimization module 104, a transaction assembly module 120, a verification module 122, an off-chain storage module 124, and security module 126.

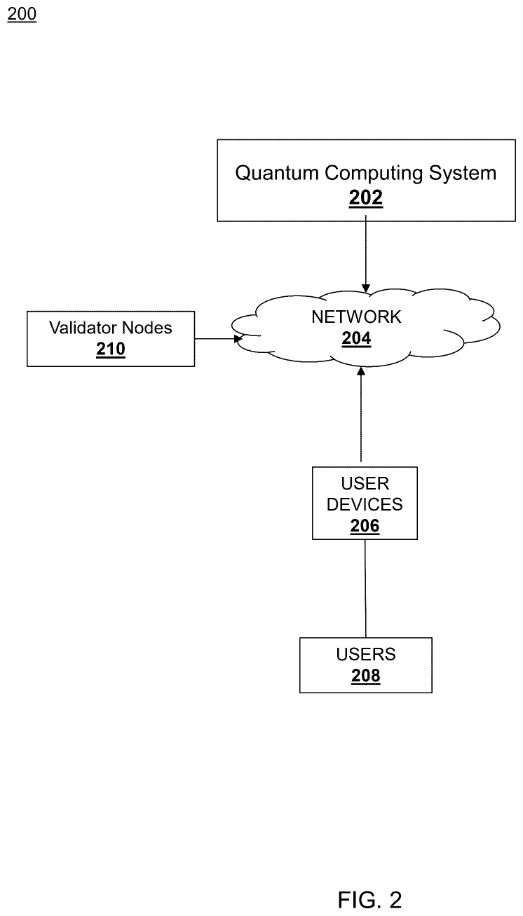

FIG. 2 illustrates system participants and communication infrastructure for a quantum-authenticated digital-token generation and verification. The network architecture comprising a quantum computing system 202 connected through network 204 to validator nodes 210 and user devices 206.

In one or more embodiments, the quantum computing system 202 may be operated independently as a service provider or may be integrated with one or more validator nodes 210 depending on deployment requirements. User devices 206 may be operated by users 208 to initiate technical processes within the quantum-authenticated digital-token processing network.

In one or more embodiments, the feedback control module 110 may be used for computing and applying real-time adjustments to system parameters, the measurement analysis and feedback module 108 may be used for analyzing quantum state metrics such as coherence and entropy, the error correction manager 106 may be used for performing adaptive error correction based on measured error syndromes, and the parameter calculation and optimization module 104 may be used for refining feedback and error correction strategies through machine learning and/or optimization techniques.

In one or more embodiments, the quantum computing device 112 may comprise a quantum system 116 that may be configured to execute quantum state evolution operations, and control devices 114 that may be configured to apply quantum gates and entanglement operations as may be directed by the classical computing device 102. The exchange interface 118 may facilitate bidirectional communication between the classical computing device 102 and the quantum computing device 112, enabling real-time updates.

The user devices 206 may be communicatively connected to the classical computing device 102 via a network 204. The classical computing device 102 may be configured to communicate with a plurality of user devices 206 operated by users 208 over a network 204. The communication between the classical computing device 102 and the user devices 206 may be facilitated via the network 204.

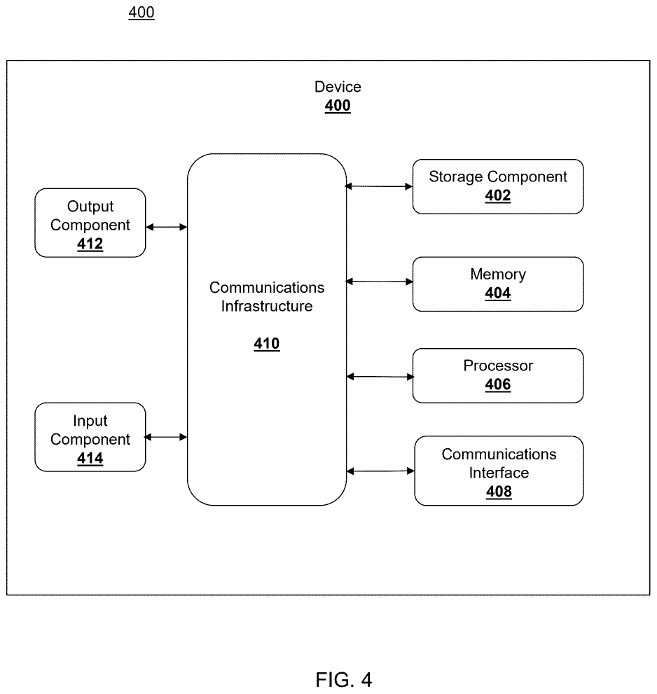

A user from the users 208 may be an individual. In one or more embodiments, a user from the users 208 may be an entity such as a business, a non-profit organization, a governmental agency, and/or any other entities. A user device 206 may be a combination of software and hardware to perform the functions of the one or more user devices 206 described herein. By way of non-limiting example, a user device 206 may be the device 400 having a processor 406 and differently arranged components, fewer components, additional components, different components than those shown in FIG. 4. (e.g., communications infrastructure 410, memory 404, input component 414, output component 412, a storage component 402, communications interface 408) where the processor 406 is configured by software to perform one or more functions of a user device 206 described herein.

Network 204 may include one or more wireless and/or wired networks. For example, network 204 may include any network capable of communicating data between devices including but not limited to a public land mobile network (PLMN), a private network, the Internet, an ad hoc network, a local area network (LAN), a cloud computing network, a wide area network (WAN), a metropolitan area network (MAN), a cellular network, an intranet, a telephone network, a fiber optic-based network or the like, and/or a combination of these or other types of networks. In some embodiments, network 204 may include a short-range wireless network that may be one of a Bluetooth wireless, Bluetooth low energy, and/or near-field communication (“NFC”) network.

In embodiments where a blockchain may be utilized one or more user devices 206 and classical computing devices 102 may provide processing power for updating and verifying a distributed ledger that may be shared between a group of user devices 206 and classical computing devices 102. The distributed ledger may be collectively updated and verified based on transactions made between the one or more user devices 206 and classical computing devices 102.

Device 400 may correspond to a device from the user devices 206 and classical computing devices 102. In some implementations, a device from the user devices 206 and classical computing devices 102 may include one or more devices 400 and/or one or more components of device 400 (e.g., communications infrastructure 410, memory 404, input component 414, output component 412, a storage component 402, communications interface 408).

In some implementations, the quantum computing device 102, the control devices 114 and the quantum system 116 may include one or more devices 400 and/or one or more components of device 400 (e.g., communications infrastructure 410, memory 404, input component 414, output component 412, a storage component 402, communications interface 408). In some implementations, the quantum computing device 102, the control devices 114 and the quantum system 116 may correspond to device 400, comprising a processor 406 and components arranged differently, with fewer components, additional components, or different components than those shown in FIG. 4 (e.g., communications infrastructure 410, memory 404, input component 414, output component 412, storage component 402, communications interface 408). The processor 406 may be configured by software to perform one or more functions described herein.

A device from the user devices 206 may be a computing and/or communication device (e.g., mobile phone, workstation, cell phone, personal computer, gaming device, smartphone, tablet computer, laptop computer, smartwatch, server computer, or any other type of computing apparatus capable of communicating with the classical computing devices 102).

The users 208 may communicate with the classical computing devices 102 through a user interface using user devices 206. In some embodiments, the classical computing devices 102 may include a web server hosting one or more websites that are accessible by users 208 over a network 204 (e.g., the Internet).

In some embodiments, the user devices 206, validator nodes 210, and/or classical computing devices 102 may be configured to use a blockchain for the storage of data used herein. A blockchain may be operated by a plurality of user devices 206, validator nodes 210, and/or classical computing devices 102 comprising a blockchain network. A blockchain may be comprised of a plurality of blocks, where each block in the blockchain may include one or more data values and a block header. The blocks of the blockchain may be secured from tampering and revision. The block header of each block in the blockchain may include at least a block reference value, a timestamp, and a data reference value. The block reference value may be a reference to the prior block added to the blockchain and the data reference value may be a reference to the one or more data values included in the respective block. In an exemplary embodiment, one or more hashing algorithms (e.g., cryptographic hashing algorithms, cryptographic hash function) may be applied to the block reference value and data reference value. The application of one or more hashing algorithms to the block reference value and data reference value may generate hash values, such that it would be necessary to regenerate the reference value if the corresponding data is modified. This may make the blockchain immutable as the propagation of any modification through the rest of the blocks in the blockchain would be necessary. Each node (e.g., validator nodes 210, user devices 206 and/or classical computing devices 102) in a blockchain network may store an entire copy, or a portion thereof, of a blockchain. As such, tampering with the blockchain may be near impossible as any modification would have to be performed on the blockchain in every node in the blockchain network prior to the addition of a new block to the blockchain. As such, the blocks of the blockchain may be secured from tampering and revision.

In some embodiments, the data values included in each block in the blockchain may include data stored for use by the user devices 206, validator nodes 210, classical computing devices 102 and/or other entities or systems. For instance, in some cases, a blockchain may be used to store activity data (e.g., user activity data performed by one or more user devices 206, and/or an activity performed by one or more validator nodes 210, and/or classical computing device 102), each activity may comprise transfer or exchange of information. In such cases, each data value may include, but is not limited to, identification data (e.g., account identifiers, biometric data/information, blockchain identifiers, public keys, or quantum computing related data) associated with one or more users 208 and/or their associated user devices 206, validator nodes 210, quantum computing device 112, and/or classical computing device 102.

The data value may further comprise activity data related to activities such as the transfer or exchange of information between the classical computing devices 102, quantum computing device 112, validator nodes 210, and/or user device 206. In certain implementations, a single blockchain may be utilized to record all activities performed by user devices 206, validator nodes 210, quantum computing device 112, and classical computing devices 102. Alternatively, separate blockchains may be maintained for each account associated with the users 208 and/or their associated user devices 206, quantum computing device 112, validator nodes 210, and classical computing devices 102.

In embodiments where a blockchain may be a permissioned blockchain (access-controlled), processor 406 of the plurality of user devices 206, validator nodes 210, and classical computing devices 102 may be configured to execute one or more sets of computer-readable instructions (software instructions) stored on storage component 402 and/or memory 404 in a trusted execution environment (a secure area of a processor).

In embodiments where a blockchain may be utilized, the blockchain may be a permissioned blockchain, public blockchain, or private blockchain. In embodiments where a blockchain may be a permissioned blockchain, the blockchain can only be accessed by participants who are allowed to access the blockchain, where the access may be controlled (e.g., verifying or validating transactions, and viewing data on the blockchain network may require permission).

In some embodiments, the user devices 206, validator nodes 210, quantum computing device 112, and/or classical computing devices 102 may be nodes in the blockchain network and may be configured to generate new blocks that may be validated by other nodes and added to the blockchain. In other embodiments, user devices 206, validator nodes 210, quantum computing device 112, and/or classical computing devices 102 may transmit data to be stored in the blockchain to a node in the blockchain network for addition thereto.

FIG. 4 is a diagram of example components of a device 400. Device 400 may correspond to a device from user devices 206, validator nodes 210, and/or classical computing devices 102. In some implementations, a user device 206, validator nodes 210, quantum computing device 112, and/or classical computing device 102 may include one or more components of device 400 and/or one or more devices 400. As shown in FIG. 4, device 400 may include a communications interface 408, a memory 404, a processor 406, a storage component 402, an input component 414, an output component 412, and a communications infrastructure 410.

By way of non-limiting example, the one or more classical computing devices 102, quantum computing device 112, validator nodes 210, and/or the one or more user devices 206 associated with the user 102 (e.g., including but not limited to paired devices, wearable devices, or portable devices) may correspond to device 400, comprising a processor 406 and components arranged differently, with fewer components, additional components, or different components than those shown in FIG. 4 (e.g., communications infrastructure 410, memory 404, input component 414, output component 412, storage component 402, communications interface 408). The processor 406 may be configured by software to perform one or more functions described herein.

Communications infrastructure 408 includes a component that permits communication among the components of device 400 such as a bus, network, multi-core message-passing scheme, message queue, etc.

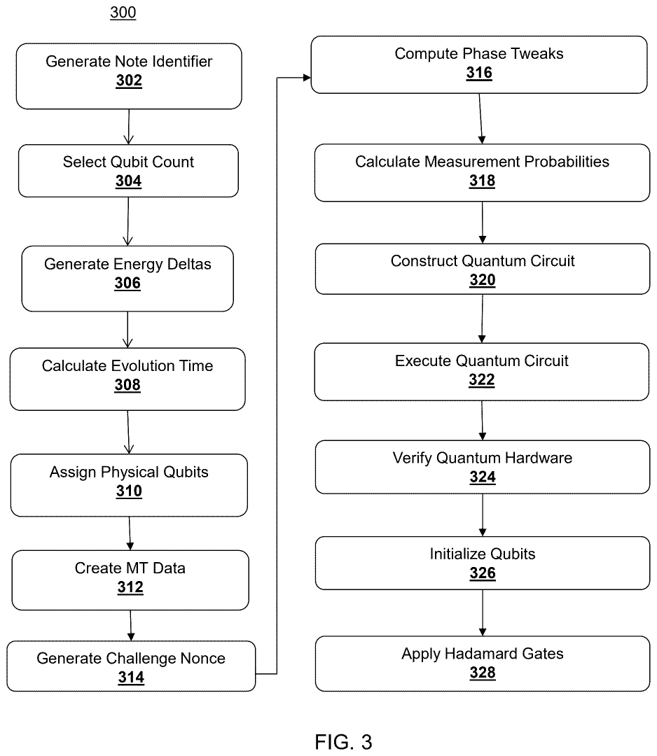

Processor 406 may be implemented in firmware, hardware, or a combination of software and hardware. Processor 406 may be connected to a communications infrastructure 410. Processor 406 may be an application-specific integrated circuit (ASIC), an accelerated processing unit (APU), a microprocessor, a field-programmable gate array (FPGA), a central processing unit (CPU), a microcontroller, a graphics processing unit (GPU), a digital signal processor (DSP), a general-purpose or special-purpose processor device specifically configured to perform the functions of the processor 406 discussed herein, or another type of processing component. In some implementations, processor 406 may include one or more processors capable of being programmed to perform a specific function. Processor 406 as described herein may be a single processor, a plurality of processors, or combinations thereof. Processor 406 may have one or more processor “cores.”. Processor 406 may be configured to execute computer-readable instructions (software instructions) stored on storage component 402 and/or memory 404. In some embodiments, the processor 406 executing software instructions stored on storage component 402 and/or memory 404 may be configured to perform or execute one or more steps or processes described with reference to FIG. 3 herein. In some embodiments, a computer-readable medium may comprise non-volatile and/or volatile memory and have stored upon it a set of software instructions that, when executed by the processor 406, cause the processor 406 to perform one or more processes described herein.

In one or more embodiments, processor 406 may be configured to perform the functions of the user devices 206, validator nodes 210, quantum computing device 112, the classical computing device 102, the feedback control module 110, the measurement analysis and feedback module 108, the error correction manager 106, the parameter calculation and optimization module 104, the transaction assembly module 120, the verification module 122, the off-chain storage module 124, the security module 126, the quantum system 116, and/or control devices 114 discussed herein as will be apparent to persons having skill in the relevant art. In some embodiments, the processor 406 may comprise one or more modules specifically configured to perform one or more functions of the processor 406. As used herein, the term “module” may be hardware or software programmed to perform one or more processes and provides an output using a received input. Based on the present disclosure, the processes, output, and input performed by different modules will be apparent to persons having skill in the relevant art.

In embodiments where a blockchain may be a permissioned blockchain, processor 406 may be configured to execute one or more sets of computer-readable instructions (software instructions) stored on storage component 402 and/or memory 404 in a trusted execution environment (a secure area of a processor).

Memory 404 may include read-only memory (ROM), a random-access memory (RAM), a static or dynamic storage device such as static memory (SRAM), magnetic memory, an optical memory, and/or a flash memory that stores information and/or instructions for use by processor 406. The memory 404 may be configured to store algorithms for use by one or more modules, communication protocols and standards, other algorithms, encryption keys, program code for modules and application programs of the classical computing devices 102, validator nodes 210, quantum computing device 112, blockchain data, communications data for blockchain nodes, user devices 206 and/or classical computing devices 102, data formatting standards and protocols, and/or other data that may be suitable for use by the classical computing devices 102 in the performance of the functions disclosed herein as will be apparent to persons having skill in the relevant art.

The memory 404 may also be configured to store data comprises algorithms for use by one or more modules, blockchain data, communication data for blockchain nodes, identification data (e.g., account identifiers, biometric data, blockchain identifier, public keys, data acquired for identification purposes) of users 208, hashing algorithms for validating and/or generating blockchain blocks, etc.

Storage component 402 may store software and/or information relating to the use and operation of device 400. For example, storage component 402 may include a hard disk. The hard disk may be a solid-state disk, a magnetic disk, a magneto-optic disk, and/or an optical disk. The storage component 402 may also include flash memory, a magnetic tape, a digital versatile disc (DVD), a cartridge, a compact disc (CD), and/or a floppy disk. The storage component 402 may also include another type of non-transitory computer-readable medium, along with a corresponding drive. The storage component 402 may also include a removable memory chip (e.g., EEPROM, PROM, etc.), and other removable storage units as will be apparent to persons having skill in the relevant art.

In one or more embodiments, memory 404 or storage component 402 may be configured to store data structures including but not limited to quantum measurement results, Merkle tree constructions, and transaction processing intermediates. In one or more embodiments, the memory 404 and/or storage component 402 may be configured to maintain blockchain data, off-chain storage repositories, and cryptographic key material and/or data. A ‘Merkle tree’ may refer to a cryptographic data structure in which each leaf node represents the hash of a data block and each non-leaf node is the hash of its child nodes, enabling efficient and secure verification of large datasets.

Input component 414 may include a component that permits device 400 to receive information, such as a keyboard, a touch screen device, a keypad, a mouse, a switch, a microphone, a button, an optical scanner, and the like. The input component 414 may also include a Radio Frequency Identification (RFID) reader, a card reader, a scale, a barcode scanner, and the like. The input component 414 may also include a sensor for sensing information such as an accelerometer, a gyroscope, an actuator, Global Positioning System (GPS) component, Assisted Global Positioning System (AGPS) component, and the like. The input component 414 may also include one or more biometric devices. The bio-metrics devices or biometric sensors may include fingerprint reader, vein reader, facial recognition device, hand geometry device, iris recognition, retina, and odour/scent recognition device, voice recognition biometric data device, one or more imaging devices (e.g., an infrared imaging device, any other imaging devices), wherein the one or more imaging devices may comprise Complementary Metal Oxide Semiconductor (CMOS) sensor and/or Charge Coupled Device (CCD) sensor, and/or the like.

In some embodiments, the input component 414 may include one or more sensors or devices to acquire data, where the data may be life cycle inventory data (e.g., onsite operations data, onsite material consumption data, onsite emissions data, onsite energy consumption data, and onsite waste data). The one or more sensors or devices may include but not limited to one or more sensors or devices for sensing information such as temperature measurement devices, emissions sensor, energy measurement devices, speed measurement devices (e.g., RADAR, LIDAR), other RADAR sensors, thermometers, nano-plasmonic sensors, chemical sensors, proximity sensor, IR sensor (Infrared Sensor), optical particle sensors, pressure sensor, humidity sensors, ionization particle sensors, light sensor, mass spectrometers, ultrasonic sensor, carbon dioxide sensors, smoke, barometers, gas and alcohol sensor, oxygen sensors, touch sensor, color sensor, nitrogen sensors, Geiger counters, tilt sensor, flow, RF radiation detectors, and level sensor or combinations thereof, and/or any other sensor required for performing one or more functions of the device 400 described herein.

In some embodiments, the input component 414 may include one or more sensors or devices to acquire data, where the data may be electrocardiogram (ECG) data that may be acquired via one or more electrodes; photoplethysmography (PPG) data that may be acquired through one or more LED-based sensors; bioimpedance data that may be measured using low-voltage electrical currents; accelerometer and gyroscope data that may be used for gait analysis; skin temperature data that may be acquired by infrared sensors; Galvanic Skin Response (GSR) data that may be acquired by electrodermal activity sensors; iris scan data that may be acquired by near-infrared cameras; and vein pattern recognition (VPR) data that may be captured using near-infrared sensors or ultrasound sensors to analyze unique blood vessel patterns.

In some embodiments, the input component 414 (e.g., a sensor for sensing information such as an accelerometer, a gyroscope, an actuator, global positioning system (GPS) component, Assisted Global Positioning System (AGPS) component, temperature measurement devices, speed measurement devices, etc.) may be anti-tampering or tamper-resistant. In some embodiments, the input component 414 may comprise a module node that acquires data (e.g., sensor data) from the input component 414 (e.g, sensor) and encrypts the data before sending it to be stored in the storage component 402 and/or memory 404.

In some embodiments, the input component 414 may be a separate component from device 400 and may be operably and/or communicatively coupled to device 400. In some embodiments, the input component 414 may be physically attached to (or manufactured into) device 400.

Output component 412 includes a component that provides output information from device 400 including but not limited to one or more light-emitting diodes (LEDs), a speaker, and/or a display. In some embodiments, the output component 412 may be a separate component from device 400 and be operably and/or communicatively coupled to device 400.

Communications interface 408 includes a component that enables device 400 to communicate with other devices, such as via a wireless connection, a wired connection, or a combination of wireless and wired connections. The component is a transceiver-like component including but not limited to a separate receiver and transmitter or a transceiver. The communications interface may be configured to allow or enable data and software to be transferred between the device 400 and external devices. For example, communications interface 408 may include a network interface (e.g., an Ethernet card), a cellular network interface, an optical interface, a communications port, a coaxial interface, an infrared interface, a radio frequency (RF) interface, a Wi-Fi interface, a PCMCIA slot and card, a universal serial bus (USB) interface, or the like. Communications interface 408 may transfer data and software in the form of signals, which may be optical, electromagnetic, electronic, or other signals as will be apparent to persons having skill in the relevant art.

In some embodiments, the communications interface 408 may comprise one or more of a mobile data network transceiver, a Wi-Fi transceiver, an NFC transceiver, a Bluetooth transceiver, a network adapter, and/or the like. In some embodiments, the communications interface 408 may be configured to allow or enable the processor 406 to communicate with one or more user devices 206 and/or classical computing devices 102 over a network 204.

In some embodiments, the communications interface 408 may comprise a subscriber identity module (SIM) of one or more wireless or mobile carriers or wireless service providers that enables the device 400 to communicate with wireless or mobile carriers or wireless service providers and access and use their services. The one or more subscriber identity modules (SIMs) may comprise International Mobile Subscriber Identity (IMSI).

In embodiments where a blockchain may be utilized, the communications interface 408 may be configured to enables device 400 to communicate with other devices and to receive data signals electronically transmitted by the user devices 206, validator nodes 210, quantum computing device 112, and/or classical computing devices 102 in a blockchain network. In embodiments where a blockchain may be utilized, the communications interface 408 may be configured to enables device 400 to communicate with other devices and to transmit data signals electronically to the user devices 206, validator nodes 210 and/or classical computing devices 102 in a blockchain network.

In some embodiments, the components or devices of the communications interface 408 may be a separate component from device 400 and be operably and/or communicatively coupled to device 400.

One or more processes described herein may be performed by device 400. The processes may be performed by device 400 based on processor 406 executing software instructions that may be stored by a non-transitory computer-readable medium such as storage component 402 and/or memory 404. As defined herein the computer-readable medium is a non-transitory memory device, where a memory device includes memory space spread across multiple physical storage devices or memory space within a single physical storage device. One or more processes described herein may be performed by processor 406 when the software instructions stored in the storage component 402 and/or memory 404 are executed. Alternatively, or additionally, one or more processes described herein may be performed by software instructions in combination with hardwired circuitry. One or more processes described herein may also be performed by hardwired circuitry in place of software instructions. As such, the embodiments and/or implementations described herein are not limited to any specific combination of software and hardware circuitry.

The number of components or arrangements shown in FIG. 4 is provided as an example. In practice, device 400 may include fewer components, additional components, different components, or differently arranged components than those shown in FIG. 4. One or more functions described herein may be performed by one or more components of device 400.

In one or more embodiments, the parameter calculation and optimization module 104 may be configured to generate Mandelstam-Tamm time-energy parameters for creating unique quantum states representing digital currency notes. The Mandelstam-Tamm parameters may be based on the fundamental energy-time uncertainty relation given by ΔE×Δt≥h/2, where ΔE may represent the total energy uncertainty that may be derived from qubit energy deltas, Δt may represent the evolution time (τ), and h may represent the reduced Planck constant (approximately 1.054571817×10\hat{ }-34 joule-seconds).

As used herein, the terms ‘energy delta’, ‘energy deltas’, and ‘Δᵢ’ may all refer to the energy gap or energy difference for qubit i in the system, that may be typically measured in Joules or as angular frequency (radians/second) when divided by h.

In one or more embodiments, the quantum computing device 112 may comprise control devices 114 and a quantum system 116 configured to execute quantum circuits with enforced timing constraints that may be derived from quantum mechanical principles.

In one or more embodiments, the feedback control module 110 may be configured to compute and apply real-time adjustments to quantum system parameters based on measurement feedback. The measurement analysis and feedback module 108 may be configured to analyze quantum state metrics including but not limited to coherence measurements, entropy calculations, and statistical analysis of measurement probability distributions. The error correction manager 106 may be configured to perform adaptive error correction based on measured quantum error syndromes and implement real-time feedback mechanisms for quantum state stabilization.

In one or more embodiments, the transaction assembly module 120 may be configured to assemble transactions comprising quantum-state-verified digital tokens with transaction inclusion lease mechanisms. In one or more embodiments, the verification module 122 may be configured to validate quantum proofs using a record-and-replay verification architecture that may enable verification without re-executing quantum circuits. In one or more embodiments, the off-chain storage module 124 may be configured to implement content-addressed storage with automatic garbage collection for managing large quantum measurement datasets.

In one or more embodiments, the quantum computing device 112 may comprise a quantum system 116 configured to execute quantum state evolution according to the Mandelstam-Tamm parameters, and control devices 114 configured to apply quantum gates and measurement operations as directed by the classical computing device 102. The exchange interface 118 may facilitate bidirectional communication between the classical computing device 102 and the quantum computing device 112, enabling real-time parameter updates and quantum operation control.

In one or more embodiments, the parameter calculation and optimization module 104 may be further configured to implement one or more energy-time uncertainty verification protocols. The processor 406 may obtain a set of real-valued Gaussian wave-packet parameters {αₖ, ω_{0,}_{ₖ}} for k=1, . . . , K from the memory 404 and/or storage component 402 or through user input via input component 414, where αₖ represents a dimensionless real amplitude parameter for the k-th Gaussian wave packet and ω_{0,}_{ₖ} represents the central angular frequency in radians per second of the k-th Gaussian wave packet. For each index k, the parameter calculation and optimization module 104 may compute energy variance σ_{e,k}=αₖ×ω_{0,}_{ₖ}, temporal uncertainty Δtₖ=1/(2×σ_{e,k}), and time-bandwidth product Pₖ=σ_{e,k}×Δtₖ. The processor 406 may compare the computed product Pₖ to the fundamental Fourier bound 1/2 and set a Fourier-saturation flag F_fourier,k based on whether |Pₖ−1/2|<ε₁, where ε₁ represents a user-defined tolerance parameter that may be stored in memory 404 and/or storage component 402.

In one or more embodiments, the parameter calculation and optimization module 104 may implement Mandelstam-Tamm bound verification by obtaining a set of Hamiltonian energy differences {Δⱼ} for j=1, . . . , J from the quantum computing device 112 through the exchange interface 118 or from pre-calibrated values that may be stored in memory 404 and/or storage component 402. For each Δⱼ, the processor 406 may compute energy variance for a two-level system as σ_{e,j}=Δⱼ/2 and orthogonalization time as t⊥ⱼ=π/Δⱼ. The control devices 114 may construct a one-qubit Mandelstam-Tamm probe circuit comprising preparation of initial state |+ [symbol] ₓ by applying Hadamard gate H, application of rotation Rz(φⱼ) where φⱼ=Δⱼ×t⊥ⱼ, optional application of a second Hadamard gate, and measurement in the Z basis. The processor 406 may verify overlap condition Oⱼ<ε₂ and product condition |σ_{e,j}×t⊥ⱼ−π/2|<ε₂, setting verification flag F_MT,j accordingly, where ε₂ represents a tolerance parameter that may be configured via the input component 414.

As used herein, a ‘Mandelstam-Tamm bound’ may refer to a quantum mechanical speed limit establishing the minimum time, τ, required for a quantum system to evolve between two orthogonal states, given by τ>πh/(2ΔE), where h is the reduced Planck constant and ΔE is the energy uncertainty

In one or more embodiments, the parameter calculation and optimization module 104 may implement Margolus-Levitin bound verification as an additional constraint. For each single-qubit energy gap Δⱼ obtained from quantum hardware calibration data that may be stored in memory 404 and/or storage component 402, the processor 406 may compute average energy Ēⱼ=|Δⱼ|, Margolus-Levitin time τ_ML,j=π/(Σⱼ₌₁^{j} Ēⱼ), and verify the product condition |(Σⱼ₌₁^{j} Ēⱼ)×τ_ML,j−π|<ε₂. The processor 406 may set verification flag F_ML,j based on compliance with this fundamental quantum speed limit and may store the verification results in memory 404 and/or storage component 402 for subsequent audit and validation purposes.

FIG. 3 is a simplified flowchart illustrating an exemplary process flow for issuing and verifying a quantum-authenticated digital currency note in accordance with one or more embodiments.

At step 302, the parameter calculation and optimization module 104 may generate unique note identifiers using cryptographic hash functions or configurable cryptographic hash (e.g., default SHA-3-256, alternative SHA-512/256, BLAKE3, etc.). In one or more embodiments, the note identifier may be computed as SHA-3 (concatenation of “note_”, current timestamp, and random value), ensuring global uniqueness across the quantum money system. The ‘quantum-authenticated digital currency note’ may refer to a digital asset whose authenticity is ensured by quantum mechanical processes, specifically quantum operations that cannot be efficiently simulated by classical means, enabling unforgeable verification based on the laws of quantum physics. As used herein, the ‘configurable cryptographic hash’ may be a hash function whose algorithm may be selected by the user or system (e.g., SHA-3-256, SHA-512/256, BLAKE3), allowing adaptability for future cryptographic requirements.

In one or more embodiments, the identifier may be computed as H (P∥T∥R), where (i) H denotes a selectable cryptographic one-way hash function (e.g. SHA3-256, BLAKE3, SHA-512/256); (ii) P is the UTF-8 byte sequence of a constant prefix such as “note_”; (iii) T is a 64-bit little-endian Unix time stamp [s]; and (iv) R is at least 256 bits of cryptographically secure random material. Implementations SHALL expose the hash choice through a configuration parameter so that future higher-security or post-quantum hash families can be substituted without changing protocol semantics.

In one or more embodiments, the note identifier may be derived as note_id=H(P∥T∥R), where H is a selectable cryptographic hash, P is the UTF-8 literal ‘note_’, T is a 64-bit little-endian Unix time-stamp [s], and R is ≥256 bits of CSPRNG entropy.

In one or more embodiments, the parameter calculation and optimization module 104 may compute a globally unique note identifier note_id by hashing a fixed prefix, the current timestamp, and a high-entropy seed with one or more configurable hash algorithms.

The system may utilize fundamental physical constants defined with high precision for quantum mechanical calculations. The reduced Planck constant h, defined as h divided by two pi, is set to 1.054 571 817 646×10⁻³⁴ joule-seconds (J·s) in all energy-time uncertainty calculations. Qubit frequencies omega_i are expressed in angular frequency units, radians per second, with typical superconducting qubit frequencies ranging from two pi times one times ten to the nine to two pi times ten times ten to the nine radians per second, corresponding to one to ten gigahertz. Energy uncertainties delta_E are calculated in joules, and time intervals tau are expressed in seconds, ensuring dimensional consistency in all Mandelstam-Tamm bound calculations according to the relationship delta_E times tau equals h-bar. The product delta_E times tau has units of action, joule-seconds, matching the units of h-bar. Here, omega_i denotes the angular frequency of the i-th physical qubit, measured in radians per second (rad/s), and is determined according to the calibration data of the target quantum hardware platform (e.g., superconducting, trapped ion, etc.), as specified in the system configuration. As used herein, the symbols ‘h-bar’ and ‘h’ are used interchangeably to denote the reduced Planck constant (h=h/2π).

At step 304, the parameter calculation and optimization module 104 may determine the number of qubits to be utilized for the quantum note, which may be selected based on security requirements and available quantum hardware resources. In one or more embodiments, the system may start with two qubits and may scale to higher numbers based on system requirements.

At step 306, the parameter calculation and optimization module 104 may generate energy delta values for each qubit. In one or more embodiments, the energy deltas may be selected from frequency ranges corresponding to superconducting qubit energy differences, such as values between four gigahertz and eight gigahertz. The energy deltas may be represented as delta_i for qubit i, where delta_i may correspond to the characteristic energy gap of the i-th qubit, measured in joules, or alternatively as f_i measured in hertz when referencing frequency.

At step 308, the parameter calculation and optimization module 104 may calculate the evolution time tau based on the Mandelstam-Tamm bound constraint. In one or more embodiments, the evolution time tau may be set to satisfy the quantum speed limit constraint tau greater than or equal to tau_MT, where tau_MT represents the minimum evolution time according to the Mandelstam-Tamm bound. The reduced Planck constant h-bar is defined as 1.054 571 817 646×10⁻³⁴ joule-seconds (J·s) and may be used throughout all related calculations. The energy uncertainty delta_E may be computed, for systems of independent, non-interacting qubits, as the root-sum-square of individual qubit energy contributions: delta_E equals the square root of the sum over i from 1 to n of (h-bar times omega_i) squared, where omega_i represents the angular frequency of the i-th qubit measured in radians per second, and n represents the total number of qubits. The Mandelstam-Tamm time bound may be calculated as tau_MT equals pi times h-bar divided by (2 times delta_E). The actual evolution time tau may be set to the maximum of tau_MT and a hardware-specific minimum time constraint tau_min, typically in the range of one times ten to the negative nine to one times ten to the negative six seconds. The parameter calculation and optimization module 104 may verify that the constraint tau greater than or equal to tau_MT times (one minus epsilon_tolerance) is satisfied, where epsilon_tolerance represents a tolerance factor typically set between zero point zero one and zero point one, and may reject quantum operations that violate this fundamental physics constraint. For systems with entanglement or interaction terms in the Hamiltonian, the energy uncertainty delta_E must be computed using the full system Hamiltonian or the quantum state's density matrix, as described herein. The above formula is provided as an engineering approximation for uncorrelated, non-interacting qubits.

At step 310, the parameter calculation and optimization module 104 may assign physical qubits within the quantum system 116 of the quantum computing device 112 corresponding to the logical qubits in the quantum note. The physical qubit assignment may take into account hardware topology, connectivity constraints, and noise characteristics of the quantum computing device 112.

The parameter calculation and optimization module 104 may implement hardware-specific minimum time constraints τ_min that account for physical limitations of quantum computing devices. For superconducting qubit systems, τ_min may be set in the range of 1×10⁻⁹ to 1×10⁻⁶ seconds based on gate operation times and decoherence characteristics. For trapped ion systems, τ_min may be set in the range of 1×10⁻⁶ to 1×10⁻³ seconds based on laser pulse durations and ion manipulation timeframes. The final evolution time may be computed as τ_final=max(τ_MT, τ_min), where τ_MT=πh/(2ΔE) represents the theoretical quantum speed limit, ensuring that both quantum mechanical constraints and hardware practicalities are satisfied. The quantum computing system 202 may maintain a database of hardware-specific parameters including minimum gate times, coherence times T₁ and T₂, and operational frequency ranges for each supported quantum computing platform.

In one or more embodiments, the verification module 122 may implement quantum hardware passport mechanisms through device-specific calibration fingerprinting that may create unique hardware identities for authentication and verification purposes. The quantum hardware passport may comprise a data structure containing unique device identifier deviceID, calibration history including but not limited to device-specific qubit frequencies {f₁, f₂, . . . , fₙ}, energy delta values {Δ₁, Δ₂, . . . , Δₙ}, measured decoherence times including T₁ relaxation times and T₂ dephasing times, noise signatures derived from measurement distributions, and cryptographic attestation signatures generated using device-specific private keys. As used herein, a ‘quantum hardware passport’ may be a data structure comprising one or more unique device identifiers, calibration data, measured noise fingerprints, and cryptographic attestations, serving as a persistent identity and authentication record for a specific quantum computing device.

In one or more embodiments, the parameter calculation and optimization module 104 may compute noise signature fingerprints using statistical analysis of quantum measurement distributions over one or more calibration circuits. The noise signature may be calculated as noise_signature=configurable cryptographic hash (e.g., default SHA-3-256, alternative SHA-512/256, BLAKE3, etc.) (histogram_hash∥variance_metrics∥correlation_matrix), where histogram_hash represents a cryptographic hash of measurement count distributions, variance_metrics represents statistical variance calculations across multiple measurement runs, and correlation_matrix represents correlation coefficients between different qubit measurement outcomes. The noise signature fingerprinting may provide device-specific metrics that are difficult to replicate or forge using classical simulation methods. The ‘noise signature fingerprints’ may refer to the statistical profiles that may be derived from quantum measurement outcomes, reflecting device-specific noise characteristics that serve as a fingerprint for hardware identification.

In one or more embodiments, the verification module 122 may update quantum hardware mechanisms periodically through recalibration processes that account for hardware drift, environmental changes, or device aging effects. The quantum hardware mechanisms update process may maintain accuracy of device fingerprinting while preserving historical device identity information through versioned quantum hardware mechanism records that may be stored by the off-chain storage module 124 in the storage component 402. Each quantum hardware mechanisms update may include but not limited to timestamp information, calibration delta measurements, and cryptographic signatures linking new calibration data to previous quantum hardware mechanism versions, enabling long-term device identity verification and auditing capabilities.

At step 312, the parameter calculation and optimization module 104 may generate a comprehensive Mandelstam-Tamm (MT) parameters data structure comprising the note identifier, energy deltas, evolution time r, total energy uncertainty ΔE, physical qubit mappings, backend name (i.e., the provider-supplied identifier of the quantum computing device 112 and/or quantum computing system), creation timestamp, and note value. This data structure may serve as the foundation for subsequent quantum circuit construction and verification processes. As used herein, ‘backend’ or ‘quantum backend’ may refer to the physical quantum computing hardware or quantum computing system 202 as may be identified by a service provider, including all associated device parameters, configuration data, and execution capabilities, and may be uniquely referenced by a provider-supplied identifier. It may also refer to a quantum computing platform or provider (e.g., IBM Quantum, IonQ), identified by a unique provider-supplied name, responsible for executing quantum circuits on physical hardware.

In one or more embodiments, the quantum computing system 202 may implement a dynamic feedback-driven quantum state evolution framework comprising coordinated operation between the classical computing device 102 and quantum computing device 112. The classical computing device 102 may include a feedback control module 110, a measurement analysis and feedback module 108, and a parameter calculation and optimization module 104 that cooperatively enable real-time adjustment of quantum gate parameters based on measurement feedback from the quantum system 116. The processor 406 may execute one or more dynamic computation algorithms that adjust quantum circuit parameters in response to evolving system conditions, wherein the adjustment process may comprise calculation of feedback phases according to the formula feedback_phase equals initial_feedback_phase times the exponential of minus decay_rate times layer_index, where initial_feedback_phase represents a base phase value proportional to evolution time, decay_rate represents a dimensionless exponential decay factor that may be ranging from 0 to 5 or within other ranges and may be applied per circuit layer when layer_index is used as a counter, and layer_index represents the current circuit layer being executed starting from zero. In alternative implementations, if the decay is parameterized over physical time t in seconds, decay_rate is assigned units of inverse seconds (s⁻¹) such that the decay is exponential in real time.

The feedback control module 110 may implement real-time parameter updates transmitted to the control devices 114 via the exchange interface 118, wherein said updates may include phase corrections, entanglement strength adjustments, and error correction frequency modifications. The measurement analysis and feedback module 108 may continuously monitor quantum state metrics including entropy and coherence, and may provide these metrics to the feedback control module 110 for dynamic system optimization.

At step 314, the parameter calculation and optimization module 104 may generate a cryptographically secure random challenge nonce using entropy sources (e.g., quantum computing system's 202 entropy sources). In one or more embodiments, the challenge nonce may comprise 32 bytes (256 bits) of randomness generated using the operating system's cryptographically secure random number generator.

In one or more embodiments, the parameter calculation and optimization module 104 may implement one or more blind challenge generation methods using cryptographically secure HMAC (Hash-based Message Authentication Code) operations to ensure information-theoretic security against device operator collusion. In one or more embodiments, the one blind challenge protocols may utilize master keys Kmaster that may be inaccessible to quantum execution environments, ensuring temporal separation between challenge commitment and parameter revelation. In one or more embodiment, the ‘blind challenge generation methods’ may refer to security methods that generate random or pseudorandom challenge parameters concealed from the quantum execution environment until a commitment is made, preventing information leakage or bias.

In one or more embodiments, the phase tweak generation may utilize HMAC-configurable cryptographic hash (e.g., default SHA-3-256, alternative SHA-512/256, BLAKE3, etc.) operations (e.g., according to the formula φᵢ=2π×(HMAC-SHA256(Kmaster, challenge_nonce∥i∥ note_id) mod 2³²)/2³²−π), where φᵢ represents the phase tweak for qubit i, challenge_nonce represents the cryptographically secure random challenge value, i represents the qubit index converted to byte representation using little-endian encoding, note_id represents the note identifier that may be encoded as UTF-8 byte string, and ∥ denotes concatenation. The resulting phase values may be normalized to the range [−π, π] to ensure compatibility with quantum rotation gate operations Rz(φᵢ).

In one or more embodiments, the parameter calculation and optimization module 104 may generate commitment hashes using configurable cryptographic hash (default SHA-3-256, alternative SHA-512/256, BLAKE3, etc.) applied to concatenated data comprising challenge_nonce, note_id, and backend_name (e.g., according to commitment_hash=SHA-256(challenge_nonce∥note_id∥backend_name)). The commitment hashes may be recorded in blockchain structures via the transaction assembly module 120 before quantum circuit parameters are revealed, implementing temporal anti-precomputation mechanisms that prevent storage-based precomputation attacks by ensuring cryptographically unpredictable parameters are not available until after commitment recording.

As used herein, a ‘commitment hash’ may be a cryptographically computed hash value over specified data elements (e.g., challenge_nonce, note_id, backend_name) that may be used in some implementations to bind protocol parameters and prevent precomputation or replay attacks.” As used herein, a ‘challenge commitment’ may refer to a publicly recorded value derived from a random challenge (e.g., a nonce), that may serve as a cryptographic anchor for subsequent protocol steps and ensuring unpredictability.

At step 316, the parameter calculation and optimization module 104 may derive phase tweaks from the challenge nonce using one or more algorithms, such as deterministic algorithms. In one or more embodiments, the phase tweaks phi_i for qubit i may be computed by seeding a pseudorandom number generator with the first eight bytes of the nonce and generating values in the range minus pi to pi.

In one or more embodiments, the parameter calculation and optimization module 104 may implement dynamic circuit layer determination based on evolution time requirements. The processor 406 may compute the number of circuit layers according to the formula: num_layers equals the maximum of three and the integer part of evolution_time in seconds multiplied by kappa_layers, where evolution_time is the duration for quantum system evolution expressed in seconds, and kappa_layers is a scaling factor with units of inverse seconds, typically set to twenty per second.

In alternative embodiments, evolution_time may be normalized to a dimensionless value by dividing the physical evolution time by a reference gate operation time, such that evolution_time_normalized equals evolution_time divided by t_gate. This dynamic scaling approach may provide technical advantages over static-depth methods by optimizing the balance between computational complexity and quantum state evolution accuracy, wherein longer evolution times receive proportionally deeper circuits while shorter computations avoid unnecessary overhead.

In one or more embodiments, the processor 406 may further implement randomized phase perturbations defined within the range perturbation ∈[−0.1×feedback_phase, 0.1×feedback_phase], wherein these perturbations may be generated using a pseudo-random number generator seeded with parameters including evolution time measurements, hardware noise profiles, and coherence metrics. The perturbation mechanism may enable controlled exploration of alternate quantum state pathways while maintaining system stability through bounded variability.

In one or more embodiments, the quantum computing system 202 may implement one or more quantum state protection mechanisms adapted for specific multi-qubit entangled states. The parameter calculation and optimization module 104 may compute protection parameters for Bell states |Φ⁺ [symbol] =(|00 [symbol] )+|11 [symbol] )/√2, GHZ states |GHZ_n [symbol] =(|0 [symbol] \hat{ }⊗n+|1 [symbol] \hat{ }⊗n)/√2, and W states |W_n [symbol] =(1/√n)(|100 . . . 0 [symbol] +|010 . . . 0 [symbol] + . . . +|000 . . . 1 [symbol] ), where n represents the number of qubits ranging from 3 to 10. The protection framework may utilize zero-decay rotation sequences defined by rotation angles φ=π×time_step/phase_factor, where time_step represents the sequential protection block index and phase_factor represents a scaling parameter that may be ranging from 0.1 to 10.0 or other ranges.

The quantum computing system 202 may implement ground-state alignment transformations comprising single-qubit rotations and multi-qubit entangling operations that align quantum states with computational bases using alignment angles θ=arccos(√(1/d)), where d represents the dimension of the protected subspace. The protection sequence may ensure that the accumulated phase across all protection layers satisfies (φ×N)=2πk for integer k may be ranging from 1 to 10 or other ranges, thereby ensuring net rotation effects return quantum states to initial configurations while providing intermediate protection against decoherence.

In one or more embodiments, the quantum computing system 202 may implement an envelope protection mechanism to enhance quantum state security against decoherence and classical simulation attacks. The parameter calculation and optimization module 104 may configure the envelope protection mechanism parameters comprising decay rates a ranging from 0.0 to 0.9 or within other ranges, phase factors β ranging from 0.5 to 5.0 or within other ranges, layer multipliers λ ranging from 1 to 10 or within other ranges, minimum layer counts Nmin typically set between 3 and 20 or within other ranges, basis rotation settings θ basis ranging from 0 to 2 π, and alignment angles φ align computed as φalign=arccos(√(1/d)) where d represents the dimension of the protected subspace.

The ‘envelope protection mechanism’ may refer to a quantum circuit design technique that applies time-dependent or randomized gate sequences to enhance robustness against decoherence and adversarial simulation.

The implementation of the envelope protection mechanism may utilize the time-dependent Hamiltonian operator H_envelope(t)=sum over i of omega_i(t) times sigma_z\hat{ }i plus sum over i of Omega_i(t) times sigma_x\hat{ }i plus sum over i and j of J_ij(t) times sigma_z\hat{ }i sigma_z\hat{ }j, where omega_i(t) represents time-dependent angular frequency parameters for qubit i derived from energy delta values and expressed in radians per second, Omega_i(t) represents single-qubit drive amplitudes computed as Omega_0i times exponential of minus alpha times t, where Omega_0i represents the initial angular Rabi rate in radians per second and alpha is the decay rate in inverse seconds (s⁻¹), and J_ij(t) represents coupling strengths between qubits i and j, modulated as J_0ij times cosine of beta times t, where J_0ij represents the base coupling strength in radians per second and beta represents the modulation frequency in radians per second. The operators sigma_x\hat{ }i sigma_z\hat{ }i denote Pauli operators acting on qubit i.

The quantum computing system 202 may implement forward envelope protection mechanism evolution through iterative application of quantum gate sequences comprising Hadamard gates H for superposition creation, rotation gates Rz(θ) and Rx(φ) for phase encoding where θ and φ are computed as step_phase×(layer+1)/(step+1), and controlled-Z (CZ) gates for entanglement generation. The gate parameters may be modified by exponential decay factors such that step_phase(t)=step_phase₀×exp(−α×layer_index), where step_phase₀ represents initial phase value, α represents decay rate parameter, and layer_index represents current gate layer index starting from 0.

In one or more embodiments, the envelope protection mechanism may apply a sequence of single-qubit and multi-qubit operations such that the total accumulated phase across all layers, computed as the product of the per-layer phase value phi_layer and the number of layers N_layers, is set to an integer multiple of two pi, that is, phi_layer times N_layers equals two pi times k for some integer k. This ensures that, after completing the full protection sequence, the net rotation effect returns the quantum states to their initial configurations, while the intermediate phases provide protection against decoherence and environmental noise. The parameters used in the envelope protection mechanism may include the decay rate alpha, which may be dimensionless per layer or specified in inverse seconds if the sequence is parameterized by real time, the phase increment per layer phi_layer in radians, the modulation frequency beta in radians per second, the layer multiplier lambda as a dimensionless parameter setting the number of protection layers, the minimum layer count Nmin as an integer, the basis rotation setting theta_basis in radians, and the alignment angle phi_align in radians, computed as the arccosine of the square root of one over d, where d is the dimension of the protected subspace. The quantum gate sequence may include Hadamard gates, single-qubit rotation gates Rz and Rx with rotation angles computed per layer as described, and controlled-Z gates for multi-qubit entanglement.

In one or more embodiments, the envelope protection mechanism may comprising applying a sequence of basis-aligned single-qubit rotations, entangling controlled-Z gates, and phase rotations, with phase increments and layer multipliers that may be specified by the parameter calculation and optimization module 104. By configuring the number of protection layers and their associated phases, the quantum computing system 202 may generate a quantum circuit that is over-specified in logical gate structure, such that, upon transpilation to the quantum hardware backend (e.g., quantum system 116's hardware), the quantum compiler or transpiler may be forced to strongly optimize and select a shortest-length, highest-fidelity native gate path. This transpiler-driven optimization may adapt the logical circuit to the current hardware calibration and device topology. As a result, the envelope protection method simultaneously may enforce quantum security via randomized phases and alignment angles, and may provide maximum robustness against hardware noise, decoherence, and classical simulation attacks. In particular, the transpiler adaptation may ensure that each execution instance is physically tailored to the hardware's real-time state, providing circuit structures that cannot be precomputed or simulated classically for adversarial purposes. In one or more embodiments, a compiler may convert logical-level quantum circuits into hardware-specific native gate sequences optimized for the topology and constraints of a particular quantum backend.

In one or more embodiments, the processor 406 may implement multi-block protection architectures wherein quantum state protection sequences may be segmented into B discrete blocks (e.g., discrete blocks ranging from 2 to 10 blocks). Each block may implement a portion of total protection layers N according to N_b=ceiling(N/B), where N_b represents layers per block ensuring integer layer allocation. The parameter calculation and optimization module 104 may optimize layer distribution across blocks according to φ_total(b)=Σᵢ₌₁^{b}(φᵢ×N_b(i)), where φ_total(b) represents accumulated phase through block b, maintaining the constraint that total accumulated phase preserves the 2πk relationship across all blocks.

The feedback control module 110 may implement inter-block coordination protocols comprising phase alignment verification, state fidelity assessment, and parameter updates for subsequent blocks. The measurement analysis and feedback module 108 may compute inter-block fidelity metrics F_ib=| [symbol] ψ_b|ψ_target [symbol] ², where ψ_b represents quantum states at block boundaries and ψ_target represents target protected states. The control devices 114 may implement idle delays between protection blocks according to τ_d=min(T_coherence/k, τ_max), where T_coherence represents the shorter of T₁ or T₂ coherence times, k represents a safety factor ranging from 4-10, and τ_max represents maximum allowable delays ranging from 1-100 μs.

In one or more embodiments, the parameter calculation and optimization module 104 may implement geometric phase-based protection utilizing path-dependent phase accumulation according to γ_g=Ω(C)= [symbol] _C A·dr, where γ_g represents geometric phase, Ω represents solid angles subtended by evolution paths C, and A represents Berry connection vector potentials. The control devices 114 may implement geometric evolution sequences following cyclic paths in parameter space according to U_g(T)=exp(−i [symbol] _C R(λ(t))dt), where U_g represents geometric evolution operators, T represents cycle times ranging from 0.1-1.0 μs, λ(t) represents time-dependent control parameters, and R represents generators of geometric transformations.

The error correction manager 106 may implement dynamic phase cancellation ensuring φ_total=φ_geometric+φ_dynamic=2πn, where φ_geometric represents accumulated geometric phases, φ_dynamic represents dynamic phase contributions, and n represents integers ranging from 1-5. The control devices 114 may integrate dynamical decoupling with geometric protection through U_total(t)=U_DD(t)·U_geometric(t), where U_DD represents dynamical decoupling operations and U_geometric represents geometric protection operations, optimizing pulse patterns according to P(t)=Σᵢ pᵢ·δ(t−tᵢ), where pᵢ represents pulse amplitudes and tᵢ represents optimized pulse timings.

At step 318, the parameter calculation and optimization module 104 may calculate expected measurement probabilities based on the quantum evolution. For each qubit i, the expected probability of measuring state |0 [symbol] may be computed as P_i=cos²((θ_i)/2), where θ_i may represent the total phase evolution given by θ_i=2π×ω_i×τ+φ_i. The ‘expected probability of measuring state |0 [symbol] may refer to the theoretically calculated probability that a given qubit, when measured in the computational basis after quantum evolution, will yield the outcome |0 [symbol] .

The phase evolution calculation theta_i equals two pᵢ times omega_i times tau plus phi_i may be performed using the Mandelstam-Tamm evolution time tau equals the maximum of (pᵢ times h-bar divided by (2 times delta_E)) and tau_min, where delta_E equals the square root of the sum over j from one to n of (h-bar times omega_j) squared, ensuring compliance with quantum mechanical constraints. The scaling factor may be defined as the maximum absolute value of theta_i taken over all qubits for the current parameter set, or alternatively, as the maximum absolute value of theta_i over all allowed parameter configurations anticipated in the system. The scaling factor may be chosen such that the scaled phase value theta_i_scaled equals (omega_i times tau plus phi_i) divided by scaling_factor, and the absolute value of theta_i_scaled does not exceed pᵢ, ensuring that all single-qubit or multi-qubit gate rotations are implemented within the physical limits and fidelity constraints of the quantum hardware. If referenced elsewhere in the document, the definition of scaling_factor shall apply throughout. The ‘scaling factor’ may refer to a normalization parameter selected to ensure that all rotation angles applied to quantum gates remain within the hardware's physically allowable limits (typically [−π, π]), defined as the maximum absolute value of computed phase evolution parameters.

At step 320, the control devices 114 of the quantum computing device 112 may construct quantum circuits implementing the Mandelstam-Tamm evolution. In one or more embodiments, the quantum circuit for each qubit i may comprise the following sequence: application of a Hadamard gate H_i to create superposition, application of a rotation gate R_z(θ_i) where θ_i encodes the energy delta and phase tweak, application of a second Hadamard gate H_i, and measurement in the computational basis. As used herein, the ‘computational basis’ may refer to the standard basis states of the qubit system, i.e., the set {|0 [symbol] , |1 [symbol] } for single-qubit systems, or {|b₁b₂ . . . bₙ [symbol] } for n-qubit systems, where bᵢ ∈{0,1}.

In one or more embodiments, the parameter calculation and optimization module 104 may implement one or more quantum circuit serialization techniques that may ensure circuit integrity during transmission between the classical computing device 102 and quantum computing device 112. The circuit serialization may utilize quantum circuit description formats including OpenQASM, Cirq JSON, or custom binary encoding schemes that preserve all gate parameters, sequence information, and metadata required for authentic quantum execution. The ‘Circuit serialization’ may refer to the process of converting a quantum circuit into a machine-readable format for storage, transmission, or execution, including standardized formats such as OpenQASM (a quantum assembly language for circuit specification) and Cirq JSON (a JSON-based serialization format for Cirq quantum circuits).

In one or more embodiments, the processor 406 may generate machine-readable circuit descriptions comprising structured data elements for each quantum operation including but not limited to gate_type ∈{H, RZ, RX, CZ, CNOT}, target_qubits specifying physical qubit indices, rotation_angles for parameterized gates expressed in radians, and execution_timing specifying relative temporal ordering. The serialized circuit representation may be encoded as circuit_data={metadata: {qubit_count, circuit_depth, creation_timestamp}, operations: [{gate_type, target_qubits, parameters, layer_index}]}, where each operation entry completely specifies a quantum gate application within the circuit sequence.

In one or more embodiments, the verification module 122 may implement cryptographic integrity verification by computing circuit integrity hashes according to:

$$circuit\_hash = SHA - 3 ( canonical\_circuit \_representation ) , where$$

canonical_circuit_representation may ensure deterministic serialization through lexicographic ordering of operations and standardized parameter encoding. The exchange interface 118 may transmit both circuit_data and circuit_hash to the quantum computing device 112, enabling the control devices 114 to independently verify circuit integrity by recomputing the hash and comparing against the transmitted value. Circuit transmission may be rejected when hash verification fails, preventing execution of corrupted or tampered quantum circuits and ensuring authentic quantum operations.

In one or more embodiments, the quantum circuit Hamiltonian for the Mandelstam-Tamm evolution may be implemented such that, for each qubit i, the accumulated phase angle is computed as theta_i equals omega_i times tau plus phi_i, where omega_i represents the angular frequency of qubit i in radians per second, tau represents the evolution time in seconds, and phi_i represents a dimensionless phase tweak for qubit i in radians, which may be derived from a challenge nonce or other system parameter. The overall effect is realized in the quantum circuit by applying a rotation gate Rz(theta_i) to each qubit i, where sigma_z\hat{ }i denotes the Pauli Z operator acting on the i-th qubit.

In one or more embodiments, the energy uncertainty used to determine the minimum quantum evolution time may be calculated as [symbol] Delta_E=sqrt(sum over i of (hbar*omega_i)\hat{ }2)z,73 , where [symbol] Delta_Ez,73 is the total energy uncertainty of the quantum system, measured in joules (J), z,73 hbarz,73 is the reduced Planck constant, approximately 1.054571817×10\hat{ }(−34) joule-seconds (J·s), z,73 omega_iz,73 is the angular frequency of the i-th physical qubit, measured in radians per second (rad/s), the sum is taken over all qubits indexed by i from 1 to N, where N is the number of physical qubits in the system. This calculation may assume that the system Hamiltonian is diagonal and non-interacting, specifically of the form z,73 H=sum over i of (hbar*omega_i*sigma_z\hat{ }i)z,73 , where z,73 sigma_z\hat{ }iz,73 is the Pauli Z operator acting on the i-th qubit. This approach also may assume the quantum state is a product state, meaning there is no entanglement or correlation between qubits.

In embodiments, where the system includes entangled states or the Hamiltonian contains interaction terms, such as terms proportional to z,73 sigma_z*sigma_z\hat{ }jz,73 , the actual energy uncertainty may differ from this approximation. In such cases, the energy uncertainty may be determined using the complete quantum state and the full system Hamiltonian, specifically as z,73 Delta_E=sqrt(expectation value of H squared, minus the square of the expectation value of H, both taken with respect to the system state)z,73 ; that is, z,73 Delta_E=sqrt(<H\hat{ }2>−<H>\hat{ }2)z,73 , where z,73 <H>z,73 denotes the expectation value of the Hamiltonian in the given quantum state. The minimum allowed evolution time, z,73 tau_MT=pi*hbar/(2*Delta_E)z,73 , where z,73 pi [symbol] is the mathematical constant approximately equal to 3.14159 and z,73 tau_MTz,73 is in seconds, may be calculated using the correct value of z,73 Delta_Ez,73 corresponding to the actual quantum state and system Hamiltonian in use, to ensure compliance with the Mandelstam-Tamm bound.

In one or more embodiments, the control devices 114 may implement one or more echo revival protocols using time-reversed quantum circuits to verify quantum coherence maintenance through state revival probability measurements. The echo circuit construction may create quantum evolution sequences according to |ψecho [symbol] =U†envelope Uenvelope |ψinitial [symbol] , where Uenvelope represents the forward envelope protection mechanism evolution operator, U†envelope represents the time-reversed conjugate transpose evolution operator, and |ψinitial [symbol] represents the initial quantum state prepared through superposition operations using Hadamard gates applied to computational ground states |0 [symbol] . An ‘echo revival protocol’ may refer to a quantum verification procedure in which a quantum evolution is followed by its exact time reversal, allowing measurement of state revival as a test of quantum coherence.

In one or more embodiments, the parameter calculation and optimization module 104 may compute echo one or more circuit parameters by applying identical gate sequences in reverse temporal order with negated phase parameters. For a forward evolution sequence comprising one or more gates {G₁(θ₁), G₂(θ₂), . . . , Gₙ(θₙ)}, the time-reversed sequence may be implemented as {Gₙ(−θₙ), Gₙ₋₁(−θₙ₋₁), . . . , G₁(−θ₁)}, where each gate Gᵢ represents quantum rotation operations and θ₁ represents phase parameters derived from challenge nonce and energy delta values.

In one or more embodiments, the measurement analysis and feedback module 108 may calculate revival probability Previval by measuring the probability of returning to the initial quantum state |00 . . . 0 [symbol] for multi-qubit systems. The revival probability may be computed as Previval=N_{00 . . . 0}/Ntotal, where N_{00 . . . 0} represents the count of measurements yielding the all-zero state and Ntotal represents total number of measurement shots. In one or more embodiments, the verification module 122 may reject quantum proofs when Previval<Pthreshold, where Pthreshold represents a predetermined threshold typically set between 0.7 and 0.9 or within other ranges that may be based on quantum hardware noise characteristics and decoherence rates.

In one or more embodiments, the minimum allowed quantum evolution time may be recalculated after the application of any quantum operation or envelope, including operations that may introduce entanglement or correlations between qubits. Specifically, after constructing the full quantum circuit including all entangling gates, interaction terms, or envelope protection mechanism operations, the energy uncertainty may be determined using the complete quantum state and the final system Hamiltonian. The energy uncertainty, Delta_E, may be defined as the square root of the expectation value of H squared minus the square of the expectation value of H, evaluated with respect to the final quantum state, i.e., Delta_E=sqrt(expectation value of H squared minus the square of the expectation value of H, both evaluated in the final system state). The system Hamiltonian, H, may include single-qubit terms of the form hbar times omega_i times sigma_z\hat{ }i and interaction terms such as J_{i,j} times sigma_z\hat{ }i times sigma_z\hat{ }j, where J_{i,j} denotes the coupling strength between qubits i and j. The minimum allowed evolution time, tau_MT, is then may be recalculated as tau_MT=pᵢ times hbar divided by two times Delta_E. In one or more embodiments, the parameter calculation and optimization module 104 may enforce that the actual evolution time, tau_exec, may be at least equal to tau_MT as determined from the final state and Hamiltonian. This may ensure that the Mandelstam-Tamm quantum speed limit is satisfied under all circuit conditions, including those involving entangled or correlated quantum states.

In one or more embodiments, the parameter calculation and optimization module 104 may be configured to implement alternative Hamiltonian formulations for enhanced quantum authentication security. The time-independent diagonal Hamiltonian H_diag for the n-qubit quantum system 116 may be expressed as:

$$H\_diag = {\sum }_{j = 1}^{n} ( {Δ}_{j} / 2 ) {σ\_z}^{⋀} j$$

where j is an integer index with 1≤j≤n corresponding to each physical qubit in quantum system 116, Δⱼ is a time-independent real-valued energy-gap parameter measured in radians per second for qubit j, and σ_z\hat{ }j denotes the Pauli Z operator acting on the j-th qubit with identity operators on all other qubits.

In one or more embodiments, the parameter calculation and optimization module 104 may be configured to implement an X-basis diagonal Hamiltonian H′_diag as:

$${H}^{′} \_diag = {\sum }_{j = 1}^{n} ( {Δ}_{j} / 2 ) {σ\_x}^{⋀} j$$

where σ_x\hat{ }j denotes the Pauli X operator acting on the j-th qubit. This alternative formulation enables authentication protocols operating in different measurement bases while maintaining quantum speed-limit constraints.

In one or more embodiments, the parameter calculation and optimization module 104 may be configured to implement a commuting two-qubit ZZ Hamiltonian H_ZZ as: H_ZZ equals the sum over all qubit pairs (i, j) in the connectivity graph E of J_i_j multiplied by (sigma_z\hat{ }i tensor sigma_z\hat{ }j), where sigma_z\hat{ }i and sigma_z\hat{ }j denote the Pauli Z operators acting on qubits i and j, respectively.

Here, E represents the set of qubit pairs defining connectivity graph edges between physical qubits in quantum system 116. J_i_j is a time-independent real-valued ZZ-coupling strength parameter for qubit pair (i, j), measured in radians per second. This formulation enables multi-qubit correlated authentication protocols that exploit quantum entanglement properties.

At step 322, the quantum system 116 may execute the constructed quantum circuit for the specified evolution time τ, ensuring that the Mandelstam-Tamm quantum speed limit is satisfied according to τ≥πh/(2ΔE), where ΔE=√(Σᵢ₌₁ⁿ (hωᵢ)²) represents the calculated energy uncertainty in Joules, τ represents the evolution time in seconds, h=1.055×10⁻³⁴ J·s represents the reduced Planck constant, and ωᵢ represents the angular frequency of the i-th qubit in radians per second. The execution may include hardware constraint enforcement where the actual evolution time is set to τ_actual=max(πh/(2ΔE), τ_hardware_min), ensuring compatibility with physical quantum device limitations. The system may continuously monitor that the constraint τ_actual≥πh/(2ΔE)×(1−ε_MT) remains satisfied throughout execution, where ε_MT represents a predefined tolerance factor, and may terminate operations that violate the quantum speed limit to maintain physics-based authentication guarantees. Hardware constraint enforcement may refer to the process of automatically adjusting quantum circuit parameters to ensure compliance with the operational limits (e.g., minimum gate durations, qubit decoherence times) of the physical quantum device in use.

In one or more embodiments, the verification module 122 may implement strict Mandelstam-Tamm constraint enforcement by continuously monitoring that τ_executed≥τ_MT×(1−ε_tolerance) throughout quantum circuit execution, where ε_tolerance represents a configurable tolerance factor typically set between 0.01 and 0.05. Upon detection of a constraint violation, the system may immediately terminate the quantum operation, log the violation event with timestamp and violation magnitude, and generate an authentication failure signal. The violation detection may include checking that the initially calculated ΔE=√(Σᵢ₌₁ⁿ(hωᵢ)²) and derived τ_MT=πh/(2ΔE) values remain consistent with the actual executed parameters within the specified tolerance. Quantum notes or tokens generated through operations that violate the Mandelstam-Tamm bound may be automatically rejected and marked as invalid, ensuring that only physics-compliant quantum states can serve as authentic digital currency or verification tokens.

In one or more embodiments, the challenge generation process may be implemented to ensure unpredictability and prevent replay attacks in the system.

At step 324, the verification module 122 may verify the connection to real quantum hardware by checking operational status, confirming non-simulator operation, and validating hardware capabilities. In one or more embodiments, the verification module 122 may verify that the selected backend (i.e., the provider's quantum computing device 112 and/or quantum computing system) is real quantum hardware by (i) polling provider metadata to confirm non-simulator status and (ii) executing a short Mandelstam-Tamm calibration circuit whose evolution parameters are chosen such that the product of the energy uncertainty ΔE and the evolution time T satisfies ΔE×τ≥π multiplied by hbar divided by 2. A backend that fails to return physically consistent measurement statistics or reports itself as a simulator may be rejected. This ensures authentic quantum money properties.

At step 326, the control devices 114 may initialize qubits in the computational ground state |0 [symbol] before applying quantum operations. The initialization process may include active reset procedures to ensure qubits start in well-defined quantum states.

In one or more embodiments, the parameter calculation and optimization module 104 may be configured to generate unoptimizable quantum speed-limit calibration circuits that may resist classical optimization while maintaining quantum authenticity. The processor 406 may select three physical qubits {Q_A, Q_B, Q_C} forming a connected subgraph on the quantum computing device's 112 coupling map, where the coupling information may be retrieved from the quantum computing device 112 via the exchange interface 118. The parameter calculation and optimization module 104 may obtain an initial rotation angle θ⁽⁰⁾ sampled via cryptographically secure pseudorandom number generator (CSPRNG) that may be implemented in the security module 126, maximum iteration count N typically set between 10 and 100 as may be configured through input component 414, shot count M for statistical estimation typically ranging from 100 to 10000 as may be specified in memory 404 and/or storage component 402, feedback constant γ>0 may be selected via CSPRNG from the security module 126, and termination threshold δθ>0 may be configured through the input component 414.

In one or more embodiments, the control devices 114 may implement the unoptimizable calibration circuit C(θ⁽ⁿ⁻¹⁾) by applying Hadamard gate H to qubit Q_A to prepare |+ [symbol] ₓ, applying parameterized rotation Rz(θ⁽ⁿ⁻¹⁾) to qubit Q_A, performing mid-circuit measurement of Q_A in X or Y basis and storing result in classical register c_A ∈{0,1}, executing conditional Pauli-string operations based on measurement outcome c_A, and applying final measurements to qubits Q_B and Q_C in Z basis. The mid-circuit measurement creates classical-controlled operations that prevent quantum circuit transpilers from removing the rotation segment, ensuring the circuit remains unoptimizable against classical preprocessing, where the transpiler prevention may be verified through circuit analysis performed by the verification module 122.

In one or more embodiments, the control devices 114 may implement comprehensive register management protocols within the quantum system 116 comprising specialized register types for distinct computational purposes. The quantum system 116 may establish logical qubit registers for primary computation, auxiliary registers for error correction and syndrome detection, and clock registers for phase estimation and feedback timing. The processor 406 may direct register initialization according to computational requirements, wherein logical qubits may be initialized to |0 [symbol] states and auxiliary qubits may remain in |0 [symbol] until error correction operations are applied.

The quantum computing device 112 may implement quantum random access memory (qRAM) protocols enabling efficient quantum state information management. The control devices 114 may configure qRAM access protocols for storing and retrieving quantum states with access timing optimized according to access_timing=min(storage_latency, retrieval_latency), where storage_latency and retrieval_latency are continuously monitored and optimized by the processor 406. The qRAM resources may enable rapid access to ancillary states and entanglement configurations during circuit execution, facilitating efficient quantum computation workflows.

In one or more embodiments, the measurement analysis and feedback module 108 may compute empirical energy variance σₑ⁽ⁿ⁾ from returned histogram counts that may be obtained from the quantum system 116 by calculating total count verification M_sum=Σ_b counts(b), energy proxy e_b=Σᵢ₌₀² bᵢ for each bitstring b, probability P(b)=counts(b)/M_sum, statistical moments E_mean⁽ⁿ⁾=Σ_b [e_b×P(b)] and E2_mean⁽ⁿ⁾=Σ_b [(e_b)²×P(b)], and energy variance σₑ⁽ⁿ⁾=√[max{0, E2_mean⁽ⁿ⁾−[E_mean⁽ⁿ⁾]²}]. The feedback control module 110 may compute updated rotation angle θ⁽ⁿ⁾=θ⁽ⁿ⁻¹⁾×[1−P_same⁽ⁿ⁾+γ], where P_same⁽ⁿ⁾ represents the probability of low-energy outcomes, with results stored in memory 404 and/or storage component 402 for subsequent iterations.

At step 328, the control devices 114 may apply the first Hadamard gates to create equal superposition states |+ [symbol] =(|0 [symbol] +|1 [symbol] )/√2 for each qubit. The Hadamard gate operation may be represented as H|0 [symbol] =|+ [symbol] ₓ, creating the necessary superposition for subsequent evolution.

In one or more embodiments, for the purpose of estimating energy-related measurement outcomes, the energy proxy e_b may be defined as the sum over all qubits i of b_i, where b_i denotes the measurement outcome (0 or 1) for qubit i. This proxy is aligned with the Hamming weight of the measurement bitstring and approximates the excitation count in the computational basis for Hamiltonians of the form H=sum over i of (1−sigma_z\hat{ }i)/2. This definition facilitates classical analysis and normalization of quantum measurement outcomes, though it may not represent the true physical energy for all Hamiltonian configurations.

In one or more embodiments, the control devices 114 may implement a barrier operation to ensure proper timing separation between circuit sections and prevent unwanted gate optimizations that could affect the intended quantum evolution.

In one or more embodiments, the control devices 114 may apply rotation gates R_z(θ_i) to implement the Mandelstam-Tamm evolution for each qubit i. The rotation angle θ_i may be computed as θ_i=(ω_i×τ+φ_i)/scaling factor, where the scaling factor may be applied to ensure numerical stability on real quantum hardware.

In one or more embodiments, the control devices 114 may implement a second barrier operation to separate the evolution section from the final measurement preparation.

In one or more embodiments, the control devices 114 may apply second Hadamard gates to each qubit to rotate the measurement basis and prepare for computational basis measurement.

In one or more embodiments, the control devices 114 may perform simultaneous measurements of all qubits in the computational basis, obtaining classical bit strings representing the quantum measurement outcomes.

In one or more embodiments, the quantum system 116 may execute the complete circuit for a specified number of shots to collect statistical measurement data. In one or more embodiments, the number of shots may be configurable, with typical values ranging from 100 to 10000 shots depending on statistical requirements and hardware availability.

In one or more embodiments, the parameter calculation and optimization module 104 may implement Fisher-optimal π-pulse calibration for enhanced quantum gate fidelity. The processor 406 may obtain calibration parameters from memory 404 and/or storage component 402 or input component 414 including initial rotation angle θ₀ typically set to π, maximum iteration count N_max typically between 10 and 50, shot count S for statistical sampling typically ranging from 1000 to 10000, and probability tolerance ε>0 typically set to 0.01. The control devices 114 may construct a single-qubit θ-probe circuit comprising application of Hadamard gate H to prepare |+ [symbol] ₓ, application of rotation Rz(θₙ), application of second Hadamard gate H, and measurement in Z basis. The processor 406 may compute empirical probability P_same(θₙ)=[Number of outcomes b=0]/S from measurement results received from quantum system 116 and analytic gradient dP/dθ(θₙ)=−(1/2)×sin(θₙ). The parameter calculation and optimization module 104 may compute Newton update θₙ₊₁=θₙ−[P_same(θₙ)/(dP/dθ(θₙ))] and normalize θₙ₊₁ into the principal interval (−π, π] via θₙ₊₁:=((θₙ₊₁+π) mod (2π))−π.

In one or more embodiments, the parameter calculation and optimization module 104 may extend Fisher calibration to two-qubit systems by preparing |+ [symbol] ᵢ⊗|+ [symbol] ⱼ via Hadamard gates Hᵢ⊗Hⱼ on qubits selected from the quantum system 116 based on coupling map information, applying rotation Rz(θₙ) on both qubits, applying controlled-NOT gate CNOT(i→j), applying final Hadamard gates Hᵢ⊗Hⱼ, and measuring both qubits in Z basis. The processor 406 may compute two-qubit probability P_same⁽²⁾(θₙ) and derivative dP⁽²⁾/dθ(θₙ) from measurement data received via exchange interface 118, implementing Newton update θₙ₊₁⁽²⁾=θₙ−[P_same⁽²⁾(θₙ)/(dP⁽²⁾/dθ(θₙ))]. The processor 406 may optionally interleave noise-monitoring sequences by applying random single-qubit Clifford operations and updating noise estimate a stored in memory 404 and/or storage component 402, pausing Newton updates when a exceeds predetermined thresholds that may be configured through input component 414.

In one or more embodiments, the error correction manager 106 may be configured to perform comprehensive single-qubit calibration operations for each qubit j∈{1, . . . , n}. The calibration procedure may comprise instructing control devices 114 to prepare state |+ [symbol] ⱼ via application of a Hadamard gate, apply a rotation R_z(Δⱼ τ), apply a second Hadamard gate, and perform measurement for N_cal shots to obtain empirical probability Pⱼ, where N_cal represents the calibration shot count typically ranging from 512 to 2,048.

In one or more embodiments, the error correction manager 106 may be configured to compute an empirical single-qubit overlap O_exp\hat{ }(j)=2Pⱼ−1| and a theoretical single-qubit overlap O_theory\hat{ }(j)=cos(Δⱼ τ/2). The error correction manager 106 may determine a rotation-error correction δⱼ=(2/τ)arccos(O_exp\hat{ }(j))−Δⱼ and update the parameter as A′ⱼ=Δⱼ+δⱼ to compensate for systematic hardware errors.

In one or more embodiments, for commuting-ZZ Hamiltonians, the error correction manager 106 may be configured to calibrate two-qubit ZZ-rotation errors by measuring empirical ZZ-coupling strengths between physically connected qubits and correcting for cross-talk effects. The error correction manager 106 may instruct control devices 114 to perform characterization measurements and store correction factors in memory 404 and/or storage component 402 for subsequent quantum circuit execution.

In one or more embodiments, the measurement analysis and feedback module 108 may collect and process the raw measurement counts, organizing them into a dictionary structure mapping bit strings to occurrence counts. For example, for a two-qubit system, the measurement counts may include entries such as “00”: count_00, “01”: count_01, “10”: count_10, “11”: count_11.

In one or more embodiments, the verification module 122 may receive a quantum proof object comprising measurement counts, challenge nonce, hardware identifier, execution timestamp, and cryptographic signatures. The proof object may serve as a record of the quantum operation that may be verified deterministically.

In one or more embodiments, the measurement analysis and feedback module 108 may be configured to implement multiple authentication metrics beyond basic probability comparison. In one or more embodiments, the measurement analysis and feedback module 108 may implement quantum state overlap calculations using normalized Mandelstam-Tamm parameters. The experimental overlap metric O_exp may be computed as the square root of the ratio of all-zero outcome count N_{0\hat{ }n} to total shot count N_shots: O_exp=√(N_{0\hat{ }n}/N_shots), where n represents the number of qubits and N_shots represents the total number of quantum measurements performed.

In one or more embodiments, the measurement analysis and feedback module 108 may implement one or more machine learning algorithms for adaptive threshold adjustment of quantum verification metrics including but not limited to noise signatures, entropy measurements, and state overlap calculations. The one or more machine learning algorithms may analyze historical quantum proof data that may be stored in memory 404 and/or storage component 402 to optimize verification parameters and detect emerging attack patterns or hardware anomalies through one or more pattern recognition and anomaly detection techniques.

In one or more embodiments, the processor 406 may implement one or more adaptive threshold algorithms using supervised learning models trained on labeled datasets comprising verified authentic quantum proofs and known attack attempts. The one or more machine learning model may utilize one or more feature vectors comprising [entropy_value, overlap_error, noise_variance, execution_time, revival_probability] with corresponding binary labels indicating authentic (1) or suspicious (0) quantum proofs. The adaptive threshold computation may be performed as threshold_new=threshold_base+α×prediction_confidence, where threshold_base represents baseline threshold values, α represents learning rate parameter ranging from 0.01 to 0.1 or within other ranges, and prediction_confidence represents model confidence scores derived from ensemble voting across multiple trained classifiers.

In one or more embodiments, the verification module 122 may implement real-time anomaly detection using unsupervised learning algorithms including but not limited to isolation forests, one-class support vector machines, or autoencoder neural networks to identify quantum proofs exhibiting characteristics inconsistent with genuine quantum hardware execution. The anomaly detection may compute anomaly scores based on deviation from learned normal behavior patterns, enabling automatic rejection of sophisticated simulation or manipulation attempts without requiring prior knowledge of specific attack methodologies. The one or more machine learning models may be updated periodically using incremental learning techniques to adapt to evolving quantum hardware characteristics and emerging attack vector developments.

In one or more embodiments, the theoretical overlap metric may be computed using the Mandelstam-Tamm time evolution: O_theory=Πⱼ₌ᵢⁿ cos(ωⱼ×τ_MT/2), where ωⱼ represents the angular frequency of the j-th qubit in rad/s, τ_MT=πh/(2ΔE) represents the calculated Mandelstam-Tamm time bound in seconds, and ΔE=√(Σᵢ₌₁ⁿ (hωi)²) represents the energy uncertainty in Joules. The overlap comparison may include tolerance checking: |O_exp−O_theory|<ε_overlap, where ε_overlap represents an acceptable deviation threshold that may be typically set between 0.05 and 0.2 depending on quantum hardware noise characteristics and measurement precision requirements.

In one or more embodiments, the measurement analysis and feedback module 108 may be configured to implement fidelity-based authentication by constructing an empirical distribution p_exp(x) over all 2ⁿ possible measurement bitstrings x, computing an ideal distribution p_theory(x) through partial classical simulation, and determining experimental fidelity as:

$$F\_exp = {\sum }_{x} √ ( p\_exp ( x ) \cdot p\_theory ( x ) )$$

This fidelity metric may provide enhanced sensitivity to quantum coherence degradation and systematic errors in quantum evolution.

In one or more embodiments, the measurement analysis and feedback module 108 may be configured to implement cross-entropy benchmarking (XEB) authentication by selecting M test bitstrings {xᵢ}ᵢ₌₁^{M}, computing theoretical probabilities p_theory(xᵢ) for each through classical simulation, and determining:

$$XEB = {\sum }_{i = 1}^{M} ( p\_exp ( {x}_{i} ) / p\_theory ( {x}_{i} ) ) - 1$$

where M represents the number of test bitstrings selected for cross-entropy analysis. This metric may enable detection of classical simulation attempts and verification of quantum advantage properties. The ‘cross-entropy benchmarking (XEB)’ may refer to a benchmarking technique that compares the experimental output distribution of a quantum circuit to its ideal theoretical distribution, used to assess quantum advantage and detect simulation attempts

In one or more embodiments, the verification module 122 may perform basic sanity checks on the proof parameters, comprising validation that energy delta values ΔE may be positive, evolution time T may be positive, and the Mandelstam-Tamm bound ΔE×τ≥h/2 may be satisfied.

In one or more embodiments, the off-chain storage module 124 may retrieve raw measurement counts from content-addressed storage using the counts Uniform Resource Identifier (URI) provided in the proof object. The retrieval process may include integrity verification through cryptographic hash validation.

In one or more embodiments, the verification module 122 may verify the Merkle tree commitment by recomputing the Merkle root from the retrieved measurement counts and comparing it against the claimed counts root in the proof object. The Merkle tree construction may utilize hash functions or configurable cryptographic hash (default SHA-3-256, alternative SHA-512/256, BLAKE3, etc.) applied to leaf nodes of the form SHA-3(bitstring∥“:”∥ count), where bitstring may represent the measurement outcome and count may represent the number of occurrences.

In one or more embodiments, the Merkle tree construction over measurement counts may follow a specific canonical ordering and hashing procedure. For each measurement outcome represented as a bit string (e.g., “00”, “01”, “10”, “11” for a two-qubit system), a leaf node hash may be computed as leaf_hash_i=SHA-3(bitstring_i∥“:”∥ count_i), where bitstring_i may represent the measurement outcome, count_i represents the occurrence frequency, and “∥” denotes concatenation. The leaf nodes are sorted lexicographically by their corresponding bit strings to ensure deterministic tree construction across all validator nodes 210.

The Merkle tree construction may proceed by pairing adjacent leaf hashes and computing parent hashes as parent_hash=SHA-3(left_child_hash∥right_child_hash). When an odd number of nodes exists at any level, the rightmost node may be duplicated to create a complete binary tree structure. This process may continue recursively until a single root hash is obtained. The verification module 122 may implement this construction using a bottom-up approach where tree_level[i+1][j]=SHA-3(tree_level[i][2j]∥tree_level[i][2j+1]) for all valid indices j, ensuring O(n log n) computational complexity for n measurement outcomes.

In one or more embodiments, the verification module 122 may validate shot count consistency by computing the total shots as the sum of individual measurement counts and comparing against the claimed total shot value in the proof object. A tolerance may be applied to account for potential hardware variations in shot delivery.

In one or more embodiments, the verification module 122 may recompute qubit probability distributions from the measurement counts and compare against expected probabilities derived from the challenge parameters. For each qubit i, the measured probability P_i\hat{ }measured may be computed as the fraction of measurement outcomes where qubit i yielded result |0 [symbol] .

In one or more embodiments, the hardware security module (HSM) may provide cryptographic security through deterministic key derivation and operation signing. In one or more embodiments, the HSM may derive private keys from a concatenation of master seed and module identifier using hash functions or configurable cryptographic hash (default SHA-3-256, alternative SHA-512/256, BLAKE3, etc.). The private key derivation may be computed as private_key=SHA-3(master_seed∥“|”∥module_identifier), ensuring deterministic but unique keys per module. In one or more embodiments, the HSM may compute public key fingerprints using hash functions or configurable cryptographic hash (default SHA-3-256, alternative SHA-512/256, BLAKE3, etc.) applied to the derived private keys. The public key computation may provide verification capabilities without exposing private key material. The hardware security module (HSM) may be a dedicated hardware component providing secure key management, cryptographic signing, and tamper-evident operation for authentication and data integrity.

In one or more embodiments, the hardware security module (HSM) may implement deterministic key derivation and cryptographic signature generation. The HSM may derive a private key for each module instance using the formula private_key=SHA-3(master_seed∥“|”∥module_identifier), where master_seed represents a cryptographically secure random value generated during system initialization, module_identifier represents a unique identifier for the specific HSM instance, and “|” serves as a delimiter. The corresponding public key may be computed using elliptic curve cryptography on the secp256k1 curve, or alternatively using post-quantum signature schemes such as CRYSTALS-Dilithium or FALCON.

The HSM signature generation process may operate on canonicalized data structures to ensure deterministic verification. For a given data object, the HSM may first compute a canonical JSON representation by ordering all keys lexicographically and removing all whitespace characters. The signature may then be computed as signature=Sign(private_key, SHA-3(canonical_data)), where Sign represents the chosen signature algorithm. The verification process may reconstruct the canonical representation and validates the signature using the corresponding public key. The HSM may additionally implement hardware attestation by including tamper-evident security features and cryptographic binding to the quantum computing device 112.

In one or more embodiments, the verification module 122 may validate the hardware security module (HSM) signature by reconstructing the signed data structure and verifying the cryptographic signature using the HSM's public key. The signed data may comprise the counts hash, operation parameters, and hardware attestation information.

In one or more embodiments, the verification module 122 may output a boolean verification result indicating whether the quantum proof may be considered authentic based on all verification checks. The verification process may be designed to be deterministic and reproducible across different validator nodes 210.

In one or more embodiments, the verification module 122 may implement multi-modal verification redundancy comprising multiple independent verification subsystems for quantum proof validation. The multi-modal architecture may include entropy analysis subsystem implemented by the measurement analysis and feedback module 108, overlap verification subsystem for theoretical-experimental state comparison, noise signature fingerprinting subsystem using device-specific metrics from quantum hardware passports, timing and commitment verification subsystem using execution timestamps and challenge commitments, and hardware attestation verification subsystem for cryptographic device authentication.

In one or more embodiments, the entropy analysis subsystem may compute Shannon entropy H=−Σᵢ pᵢ log₂(pᵢ) where pᵢ represents probability of measuring outcome i, and reject quantum proofs when H<Hₘᵢₙ or H>Hₘₐₓ where Hₘᵢₙ and Hₘₐₓ represent entropy bounds derived from quantum hardware noise characteristics. The overlap verification subsystem may compute overlap error as |Oₑₓₚ−O_{theory}| where Oₑₓₚ=√(N_{00 . . . 0}/Nₛₕₒₜₛ) represents experimental overlap and O_{theory}=Πᵢ cos(θᵢ/2) represents theoretical overlap calculated from circuit parameters. The noise signature subsystem may compare measured noise fingerprints against stored quantum hardware passport data using statistical distance metrics.

In one or more embodiments, the verification module 122 may implement quorum-based verification logic requiring that a predetermined minimum number of verification subsystems succeed prior to quantum proof acceptance. The quorum threshold may be configured as Nₛᵤccₑₛₛ≥[Nₜₒₜₐₗ×qᵤₒᵣᵤₘ_fraction] where Nₛᵤccₑₛₛ represents number of successful verification subsystems, Nₜₒₜₐₗ represents total number of verification subsystems, quorum_fraction represents required success fraction that may be typically set between 0.6 and 0.8 or between other ranges, and Π represents ceiling function. In the event that insufficient verification subsystems succeed, the quantum proof may be automatically rejected with detailed failure analysis logged for forensic investigation.

In one or more embodiments, the processor 406 may implement adaptive weight assignment for different verification subsystems based on their historical accuracy and reliability metrics. The weighted verification score may be computed as Sᵥₑᵣᵢf_{y}=Σᵢ wᵢ×rᵢ where wᵢ represents weight assigned to verification subsystem i, rᵢ∈{0,1} represents binary result from subsystem i, and weights are normalized such that Σᵢ wᵢ=1. The adaptive weight adjustment may utilize exponential moving averages to track subsystem performance over time according to wᵢ⁽ⁿ⁺¹⁾=α×accuracyᵢ⁽ⁿ⁾+(1−α)×wᵢ⁽ⁿ⁾ where α represents learning rate parameter and accuracyᵢ⁽ⁿ⁾ represents recent accuracy measurement for subsystem i. The multi-modal redundancy architecture may provide defense-in-depth security against various attack vectors while enabling graceful degradation when individual verification subsystems experience failures or reduced reliability.

In one or more embodiments, the verification process may enable validation of quantum authenticity without requiring re-execution of expensive quantum circuits.

In one or more embodiments, the measurement analysis and feedback module 108 may be configured to implement CHSH-based interactive authentication protocols. The CHSH parameter S may be defined as:

$$S = 〈 {A}_{0} {B}_{0} 〉 + 〈 {A}_{0} {B}_{1} 〉 + 〈 {A}_{1} {B}_{0} 〉 - 〈 {A}_{1} {B}_{1} 〉$$

where each correlator term [symbol] AᵢBⱼ [symbol] represents measurement correlations between spatially separated qubits, computed from measurement statistics as:

$$〈 {A}_{i} {B}_{j} 〉 = ( {N}_{++} + {N}_{--} - {N}_{+ -} - {N}_{- +} ) / N\_shots$$

where N₊₊, N₋₋, N₊₋, N₋₊ represent counts for respective measurement outcome combinations. The ‘CHSH-based interactive authentication’ may refer to Quantum authentication method employing the Clauser-Horne-Shimony-Holt (CHSH) inequality to verify entanglement and quantum nonlocality beyond classical thresholds.

In one or more embodiments, the control devices 114 may be configured to prepare Bell pairs |Φ⁺ [symbol] =(|00 [symbol] +|11 [symbol] /√2 across spatially separated qubits within quantum system 116, perform measurements with basis choices Aᵢ and Bⱼ selected randomly by parameter calculation and optimization module 104, and verify that measured correlations exceed classical bounds |S|>2. The verification process confirms quantum hardware operation if the measured value of |S| exceeds the classical bound, i.e., |S|>2, which is only achievable by quantum entanglement. Quantum mechanics allows up to |S|≤2√2, which provides a definitive distinction from classical systems.

In one or more embodiments, the feedback control module 110 may be configured to coordinate k independent authentication rounds by instructing parameter calculation and optimization module 104 to generate fresh random parameters {Δⱼ\hat{ }(r)} for each round r∈{1, . . . , k}. The feedback control module 110 may require at least P % of the k rounds to satisfy authentication criteria before declaring a final authentication result, where P represents a configurable percentage threshold typically set between 60% and 90%.

In one or more embodiments, the feedback control module 110 may implement quorum-based consensus logic by storing intermediate results from each round in storage component 402 and applying statistical analysis to determine the overall authentication outcome. The multi-round approach reduces the probability of successful statistical attacks while maintaining computational efficiency through parallel execution of authentication circuits.

In one or more embodiments, the transaction assembly module 120 may create a lease data structure comprising height_req (earliest inclusion block), height_exp (latest inclusion block), grace_blocks (tolerance period), and penalty (stake amount to be slashed).

The lease parameters may be determined based on user requirements and network conditions.

In one or more embodiments, the transaction assembly module 120 may attach the lease data structure to a transaction containing a quantum-verified digital token. The transaction may include references to the quantum proof, off-chain measurement data, and the terms of the lease data structure.

In one or more embodiments, validator nodes 210 in the consensus network may track the lease data structure deadlines using one or more distributed lease data structure monitoring mechanisms. Each validator may maintain data structures mapping block heights to lists of transaction hashes with expiring leases.

In one or more embodiments, during block proposal, validator nodes 210 may prioritize leased data structure transactions based on their expiration deadlines. Transactions approaching their lease data structure expiration may be given higher priority in block inclusion to avoid penalty triggering.

In one or more embodiments, the verification module 122 may monitor for lease data structure violations by checking whether leased data structure transactions may have been included within their specified timeframes. A lease data structure violation may occur when the current block height exceeds height_exp+grace_blocks without the transaction being committed.

In one or more embodiments, upon detection of a lease data structure violation, the verification module 122 may implement stake slashing by debiting the penalty amount from the responsible validator node's 210 stake balance. The slashing mechanism may serve as an economic incentive for validator nodes 210 to honor lease data structure commitments.

In one or more embodiments, the verification module 122 may record slashing events in persistent storage (e.g., memory 404 and/storage component 402) with details comprising validator nodes 210 identifier, transaction hash, penalty amount, and block height. This information may be used for audit purposes and validator nodes 210 reputation tracking.

In one or more embodiments, the verification module 122 may implement automatic validator nodes 210 jailing when accumulated slashing penalties exceed the validator nodes 210 available stake balance. Jailed validator nodes 210 may be temporarily or permanently excluded from consensus participation.

In one or more embodiments, the verification module 122 may implement forensic analysis capabilities for post-incident investigation of quantum security breaches or verification failures. The forensic analysis system may comprise detailed logging mechanisms that record quantum circuit execution metadata including circuit construction timestamps, gate parameter values, measurement outcome distributions, hardware calibration states, and temporal correlation data between quantum operations and potential security events.

In one or more embodiments, the measurement analysis and feedback module 108 may implement forensic reconstruction algorithms capable of reconstructing quantum proof generation processes from stored metadata. The reconstruction process may analyze quantum circuit execution logs, measurement outcome patterns, hardware fingerprint data, and temporal execution sequences to identify potential attack vectors, hardware manipulation attempts, or protocol violations. The forensic reconstruction may utilize one or more correlation analysis algorithms that compute statistical relationships between suspicious quantum proof characteristics and known attack signatures according to correlation_coefficient=Σᵢ(xᵢ−x̅)(yᵢ−y̅)/√[Σᵢ(xᵢ−x̅)²Σᵢ(yᵢ−y̅)²], where xᵢ represents observed quantum proof metrics, yᵢ represents baseline authentic proof metrics, and x̅, y̅ represent corresponding mean values.

In one or more embodiments, the verification module 122 may implement one or more automatic incident detection and alerting systems that monitor quantum proof patterns in real-time for anomalous characteristics. The incident detection may utilize statistical process control methods including control chart analysis, where alert conditions may be triggered when quantum proof metrics exceed control limits computed as UCL=μ+k×σ and LCL=μ−k×σ, where represents historical mean of authentic quantum proof metrics, a represents standard deviation, and k represents control limit factor that may be typically set between 2 and 3 or between other ranges. The automatic alerting system may generate detailed forensic reports comprising incident classification, severity assessment, affected quantum hardware identifiers, temporal incident boundaries, and recommended remediation actions for security administrators.

In one or more embodiments, the off-chain storage module 124 may maintain forensic audit trails comprising immutable logs of all quantum circuit executions, verification decisions, security events, and administrative actions. The audit trail structure may include cryptographically signed entries containing {timestamp, operation_type, quantum_device_id, circuit_hash, verification_result, administrator_id, digital_signature}, where each entry is cryptographically may be linked to previous entries using one or more hash chain mechanisms to prevent tampering or selective deletion of forensic evidence. The forensic audit trails may support compliance verification, regulatory reporting, and long-term security analysis capabilities.

In one or more embodiments, a censorship detection system may be implemented to identify malicious validator nodes 210 attempting to manipulate transaction propagation.

In one or more embodiments, validator nodes 210 may implement protocol monitoring (e.g., gossip protocol monitoring) by recording first-seen timestamps for every transaction received through the peer-to-peer network. The timestamps may be stored in data structures enabling efficient delay computation and statistical analysis.

In one or more embodiments, the measurement analysis and feedback module 108 may compute propagation delays by subtracting transaction broadcast timestamps from arrival timestamps. The delay computation may account for network latency and clock synchronization differences between nodes.

In one or more embodiments, the measurement analysis and feedback module 108 may maintain a rolling window of delay samples for baseline computation. In one or more embodiments, the rolling window may contain at least 100 delay samples to provide statistically significant baseline measurements.

In one or more embodiments, the measurement analysis and feedback module 108 may compute statistical metrics including running mean and standard deviation of the delay samples. The baseline statistics may be updated continuously as new transactions arrive and the rolling window advances.

In one or more embodiments, the measurement analysis and feedback module 108 may identify outlier delays that exceed the baseline mean by more than a threshold number of standard deviations. In one or more embodiments, the threshold may be set to two standard deviations to balance sensitivity and false positive rates.

In one or more embodiments, the measurement analysis and feedback module 108 may calculate the percentage of recent transactions exhibiting outlier delays. The outlier percentage may be computed over a configurable window of recent transactions to detect sustained censorship attempts.

In one or more embodiments, the measurement analysis and feedback module 108 may implement statistical process control methods to identify anomalous transaction propagation patterns. The measurement analysis and feedback module 108 may maintain a rolling window of inter-arrival delay samples with a minimum size of 100 observations to ensure statistical significance. For each incoming transaction, the delay is computed as delay_i=arrival_timestamp_i−broadcast_timestamp_i, accounting for network time protocol (NTP) synchronization between nodes.

The baseline statistics may be continuously updated using exponential weighted moving averages to adapt to changing network conditions. The running mean may be computed as μ_new=α×delay_current+(1−α)×μ_old, where α represents a smoothing factor typically set to 0.1. The running variance may be computed as σ²_new=α×(delay_current−μ_new)²+(1−α)×σ² old. Outlier detection triggers when delay_i>μ+k×σ, where k represents the threshold parameter typically set to 2.0 for 95% confidence intervals.

A censorship alert mechanism may be activated when the percentage of outlier delays exceeds a predetermined threshold over a sliding window of recent transactions. The outlier percentage may be computed as outlier_rate=(count_outliers/window_size)×100%, where count_outliers represents the number of delays exceeding the threshold within the current window. Alert generation may occur when outlier_rate>CENSORSHIP_THRESHOLD, typically set to 30%. The measurement analysis and feedback module 108 may implement escalating responses including increased monitoring frequency, validator reputation penalties, and economic sanctions proportional to the severity and duration of detected censorship behavior.

In one or more embodiments, the verification module 122 may trigger censorship alerts when the outlier percentage exceeds a predetermined threshold, such as 30% of recent transactions. The alert mechanism may include logging, notification, and potential economic penalties for suspected censors.

In one or more embodiments, the verification module 122 may implement responsive measures including increased monitoring, validator nodes 210 reputation adjustments, and potential economic sanctions against validator nodes 210 consistently associated with censorship behavior.

In one or more embodiments, a multi-block commit-reveal mechanism may be implemented to prevent manipulation of random number generation in consensus protocols.

In one or more embodiments, during block proposal for height n, the proposing validator nodes 210 may generate a cryptographically secure random nonce for use in block n+1. The nonce generation may utilize high-entropy sources to ensure unpredictability.

In one or more embodiments, the proposing validator node 210 may compute a cryptographic commitment to the future nonce using one-way hash functions configurable cryptographic hash (default SHA-3-256, alternative SHA-512/256, BLAKE3, etc.). The commitment may be computed as commit_n+1=SHA-3(nonce_n+1), where nonce_n+1 may represent the nonce intended for block n+1.

In one or more embodiments, the proposing validator node 210 may include the commitment commit_n+1 in the header of block n, creating a cryptographic binding between the current block and the future nonce value.

In one or more embodiments, the proposing validator node 210 may store the raw nonce nonce_n+1 in persistent storage (e.g., memory 404 and/or storage component 402) with an association to block height n+1. The storage mechanism may comprise write-ahead logging to ensure durability across system restarts.

In one or more embodiments, during block proposal for height n+1, the proposing validator node 210 may retrieve the previously committed nonce nonce_n+1 from persistent storage and include it as the reveal value in block n+1.

In one or more embodiments, other validator nodes 210 may verify the reveal by computing SHA-3(nonce_n+1) and comparing the result against the commitment commit_n+1 recorded in block n. This verification may ensure that the revealed nonce matches the previously committed value.

In one or more embodiments, the verification module 122 may reject blocks containing invalid reveals, ensuring that validators may not manipulate random number generation by changing nonce values after seeing other validators' actions.

In one or more embodiments, the verification module 122 may implement cleanup mechanisms to remove old commit-reveal data beyond a configurable retention period, maintaining system efficiency while preserving security properties.

In one or more embodiments, a system for content-addressed off-chain storage of quantum measurement data may be implemented to provide integrity guarantees while managing large datasets efficiently.

In one or more embodiments, the off-chain storage module 124 may receive quantum measurement counts organized as key-value pairs mapping bit strings to occurrence frequencies. The measurement data may be accompanied by metadata comprising block height and Merkle root information.

In one or more embodiments, the off-chain storage module 124 may construct a payload (e.g., JSON payload) containing the measurement data and associated metadata. The payload (e.g., JSON payload) construction may utilize one or more formatting or data encoding methods (e.g., canonical formatting with lexicographically ordered keys and no whitespace) to ensure deterministic serialization.

In one or more embodiments, the off-chain storage module 124 may compute a cryptographic hash of the data representation (e.g., canonical JSON representation) using hash functions or configurable cryptographic hash (default SHA-3-256, alternative SHA-512/256, BLAKE3, etc.). The hash computation may serve as both content identifier and integrity verification mechanism.

In one or more embodiments, the off-chain storage module 124 may generate a content-addressed URI using the computed hash as the identifier. In one or more embodiments, the URI may follow InterPlanetary File System (IPFS) compatible formatting such as “ipfs://hash_value” to enable interoperability with distributed storage systems.

In one or more embodiments, the off-chain storage module 124 may store the payload (e.g., JSON payload) in local file storage (e.g., memory and/or storage component 402) using the hash value as the filename. The storage implementation may include atomic write operations to prevent corruption during concurrent access.

In one or more embodiments, the off-chain storage module 124 may implement file-level locking mechanisms to ensure thread safety and prevent corruption during concurrent read/write operations. The locking may utilize operating system primitives such as fcntl for reliable coordination.

In one or more embodiments, the off-chain storage module 124 may implement garbage collection mechanisms to remove outdated measurement data based on configurable retention policies. The garbage collection may be triggered periodically and may consider block height thresholds for data removal decisions.

In one or more embodiments, the off-chain storage module 124 may implement alternative storage backends including distributed file systems such as InterPlanetary File System (IPFS), Swarm, Storj, traditional cloud storage services, or hybrid storage architectures combining local and remote storage. The content addressing scheme may utilize alternative hash functions or content identifiers, with configurable parameters for redundancy, availability, and geographic distribution.

In one or more embodiments, the verification module 122 may implement alternative verification mechanisms that may include but are not limited to zero-knowledge proofs of quantum execution, verifiable quantum computation protocols, or quantum advantage verification schemes that demonstrate computational tasks infeasible for classical computers. The verification module 122 may implement succinct non-interactive arguments of knowledge (SNARKs), succinct transparent arguments of knowledge (STARKs), or interactive proof systems for quantum circuit execution. The Zero-knowledge proofs' may refer to cryptographic protocols enabling one party to prove knowledge of a statement's validity to another party without revealing the underlying information. The ‘SNARKs’ (succinct non-interactive arguments of knowledge) and ‘STARKs’ (succinct transparent arguments of knowledge) may be types of zero-knowledge proofs that may allow efficient, verifiable computation with strong privacy guarantees. The ‘Interactive proof systems’ may require multiple rounds of communication between prover and verifier.

In one or more embodiments, the measurement data serialization may support alternative formats including but not limited to Protocol Buffers, MessagePack, CBOR, or custom binary encoding schemes optimized for quantum measurement statistics. The serialization format may include but not limited to compression algorithms, error correction codes, or authentication tags to ensure data integrity and efficient storage utilization.

In one or more embodiments, the off-chain storage module 124 may provide retrieval services enabling recovery of measurement data using content-addressed URIs. The retrieval process may include integrity verification through hash validation.

In one or more embodiments, a persistent storage system may be implemented to provide concurrent access, data durability, and consistency across validator nodes 210 instances.

In one or more embodiments, the persistent storage system may initialize database (e.g., SQLite) connections with write-ahead logging (WAL) mode enabled. The WAL mode may provide improved concurrency by allowing simultaneous read operations while write operations are in progress.

In one or more embodiments, the persistent storage system may create database schemas using statements to ensure table persistence across validator nodes 210 restarts. The schema creation may avoid dropping existing tables to preserve data continuity.

In one or more embodiments, the persistent storage system may implement thread-safe database operations using mutex locks to coordinate access across multiple threads and processes. The locking mechanisms may prevent race conditions and ensure data consistency.

In one or more embodiments, the persistent storage system may maintain validator nodes 210 stake balances in persistent tables with atomic update operations. Stake modifications may be implemented (e.g., implemented using SQL transactions) to ensure consistency during concurrent access.

In one or more embodiments, the persistent storage system may track spent notes using duplicate detection mechanisms to prevent double-spending attacks. The spent note tracking may comprise transaction hash, block height, and processing timestamp information.

In one or more embodiments, the persistent storage system may record slashing events with audit trails comprising validator identifier, penalty amount, violation type, and temporal information. The slashing records may support compliance and forensic analysis requirements.

In one or more embodiments, the persistent storage system may implement commit-reveal state management with automatic cleanup of expired entries. The state management may include challenge nonce storage, commitment tracking, and reveal validation.

In one or more embodiments, the persistent storage system may provide backup and recovery mechanisms comprising database checkpointing, transaction log management, and disaster recovery procedures.

In one or more embodiments, the verification module 122 may coordinate distributed agreement while maintaining quantum money security properties.

In one or more embodiments, the verification module 122 may implement validator nodes 210 selection using one or more algorithms (e.g., round-robin or stake-weighted algorithms) to determine block proposers. The selection mechanism may consider one or more factors including but not limited validator nodes 210 reputation, stake balance, and historical performance metrics.

In one or more embodiments, the selected proposer may construct block proposals by prioritizing leased data structure transactions based on expiration deadlines and including normal transactions based on fee optimization criteria. The block construction may respect size limits and resource-consumption limits.

In one or more embodiments, the verification module 122 may distribute block proposals to all validator nodes 210 in the network using one or more protocols (e.g., protocols gossip with redundancy and error correction mechanisms). The distribution may include proposal signatures and validator nodes 210 endorsements.

In one or more embodiments, each validator nodes 210 may perform block validation comprising quantum proof verification, transaction structure validation, lease data structure compliance checking, and commit-reveal verification. The validation process may be deterministic and reproducible.

In one or more embodiments, validator nodes 210 may submit signed votes for valid block proposals using cryptographic signatures that may be aggregated for consensus determination. The voting mechanism may implement one or more methods comprising Byzantine fault tolerance with configurable thresholds.

In one or more embodiments, the verification module 122 may aggregate votes and determine consensus achievement when the vote count exceeds the required threshold (typically ≥2f+1 where f may represent the maximum number of byzantine validators).

In one or more embodiments, the verification module 122 may implement one or more voting mechanisms. In one or more embodiments, the verification module 122 may implement alternative Byzantine fault-tolerant protocols beyond Tendermint, including but not limited to practical Byzantine fault tolerance (pBFT), Istanbul BFT, HotStuff, Algorand consensus, GRANDPA finality gadget, or hybrid proof-of-stake/proof-of-work mechanisms. Each consensus protocol may require specific adaptations for quantum proof validation, with configurable parameters for block time, finality guarantees, and fault tolerance thresholds.

In one or more embodiments, the cryptographic signature schemes may include post-quantum secure alternatives such as CRYSTALS-Dilithium, FALCON, SPHINCS+, or hash-based signatures to ensure long-term security against quantum computing attacks. The verification module 122 may implement hybrid signature schemes combining classical elliptic curve signatures with post-quantum alternatives for transitional security. Alternative hash functions may include SHA-256, SHA-512, BLAKE2, BLAKE3, Keccak variants, or quantum-resistant hash functions such as those based on lattice problems or multivariate cryptography.

In one or more embodiments, the commit-reveal mechanism may be generalized to include alternative commitment schemes such as Pedersen commitments, polynomial commitments, or zero-knowledge proof systems. The commitment computation may utilize different hash functions, commitment opening procedures, or distributed randomness generation protocols such as verifiable random functions (VRFs), threshold signatures, or distributed key generation (DKG) protocols.

In one or more embodiments, upon consensus achievement, all validator nodes 210 may apply the committed block by updating their local state, marking transactions as confirmed, and updating stake balances according to the reward distribution formula.

In one or more embodiments, the verification module 122 may implement global mempool (a memory pool is a temporary in-memory storage) eviction by removing all committed transactions from validator mempools across the network. The eviction mechanism may prevent transaction replay and maintain consistency.

In one or more embodiments, the verification module 122 may update block height, trigger garbage collection of outdated data, and prepare for the next consensus round. The state transitions may be atomic and consistent across all participating validator nodes 210.

In one or more embodiments, a system for aligning incentives with quantum resource consumption and network security requirements may be implemented.

In one or more embodiments, the transaction assembly module 120 may calculate base transaction fees proportional to quantum hardware shots executed during quantum proof generation. The shot-based fee component may be computed as fee_shots=total_shots×SHOT_RATE, where SHOT_RATE may represent the cost per quantum shot.

In one or more embodiments, the transaction fee calculation may implement a multi-component pricing model that accounts for quantum resource consumption and economic incentives. The base fee component may be computed as fee_quantum=total_shots×SHOT_RATE×difficulty_multiplier, where total_shots represents the number of quantum measurements executed, SHOT_RATE represents the cost per shot in base currency units, and difficulty_multiplier represents a dynamic adjustment factor based on network congestion and quantum hardware availability.

The ad-valorem fee component may be calculated as fee_value=token_face_value×AD_VALOREM_RATE×(1+volatility_adjustment), where token_face_value represents the nominal value of the digital token, AD_VALOREM_RATE represents a percentage fee rate, and volatility_adjustment represents a dynamic factor based on market conditions. The total transaction fee may be computed as total_fee=fee_quantum+fee_value+fixed_overhead, where fixed_overhead accounts for network processing costs.

The fee burning mechanism may implement deflationary tokenomics by permanently removing a portion of collected fees from circulation. The burned amount may be calculated as burned_fee=total_fee×BURN_PERCENTAGE, where BURN_PERCENTAGE represents a configurable parameter typically set between 10% and 50%. The remaining fee amount (total_fee−burned_fee) may be distributed to validator nodes 210 according to their stake weights and participation in consensus. The verification module 122 may maintain running totals of burned fees for monetary policy analysis and updates the circulating supply accordingly.

In one or more embodiments, the transaction assembly module 120 may calculate ad-valorem fee components proportional to digital token face values. The value-based fee component may be computed as fee_value=token_value×FEE_RATE, where FEE_RATE may represent the percentage fee on token value.

In one or more embodiments, the transaction assembly module 120 may compute total transaction fees as the sum of shot-based and value-based components: total_fee=fee_shots+fee_value. Additional fee components may be added based on system requirements.

In one or more embodiments, the verification module 122 may accumulate quantum work metrics during block processing by summing total shot counts across all transactions in the block. The quantum work sum may be computed as quantum_work=sum over all transactions of total_shots.

In one or more embodiments, the verification module 122 may calculate block rewards using a formula combining fixed subsidies with quantum work incentives. The block reward may be computed as reward=BLOCK_SUBSIDY+ALPHA×quantum_work, where ALPHA may represent the weight parameter for quantum work.

In one or more embodiments, the verification module 122 may implement fee burning mechanisms by destroying a predetermined percentage of collected fees. The burned amount may be computed as burned_fees=total_fees×BURN_PERCENTAGE, with the remainder distributed to validator nodes 210.

In one or more embodiments, the verification module 122 may credit proposer stake balances with the sum of block rewards and non-burned fees. The crediting operation may be atomic and may update persistent storage with transaction logging.

In one or more embodiments, the verification module 122 may implement an economic model with alternative fee structures including subscription-based pricing, usage-based metering, auction-based fee discovery, or dynamic pricing based on supply and demand for quantum computing resources. The fee calculation may incorporate time-of-day pricing, quality-of-service tiers, or bulk discount mechanisms for high-volume users.

In one or more embodiments, the verification module 122 may implement alternative reward distribution mechanisms that may include stake-weighted proportional rewards, equal distribution among active validator nodes 210, performance-based bonuses, or lottery-based reward allocation. The block reward formula may incorporate additional factors such as validator nodes 210 uptime, historical performance metrics, geographic distribution incentives, or contribution to network security and decentralization.

In one or more embodiments, the verification module 122 may implement token one or more burning mechanism that may implement alternative deflationary policies including time-locked burning, conditional burning based on network metrics, or community governance-controlled burning rates. Alternative monetary policies may include inflation targeting, supply cap mechanisms, or hybrid elastic supply models that adjust token issuance based on network usage and economic conditions.

In one or more embodiments, the verification module 122 may implement dynamic fee adjustment mechanisms based on many factors including but not limited to network congestion, quantum hardware availability, and economic equilibrium requirements. The adjustment mechanisms may respond to market conditions and resource constraints.

In one or more embodiments, the parameter calculation and optimization module 104 may initialize quantum backend interfaces supporting multiple provider implementations including but not limited to IBM Quantum, IonQ, Rigetti, and future quantum computing platforms.

In one or more embodiments, each backend implementation may provide connection verification methods to validate real quantum hardware availability and operational status. The verification may comprise capability checking, queue status monitoring, and hardware health assessment.

In one or more embodiments, backend implementations may provide Mandelstam-Tamm parameter generation methods tailored to specific quantum hardware characteristics. The parameter generation may consider one or more factors comprising qubit topology, gate fidelities, and noise models specific to each platform.

In one or more embodiments, backend implementations may provide challenge generation methods. The challenge generation methods may optimize for hardware-specific constraints and capabilities.

In one or more embodiments, backend implementations may provide quantum execution methods that submit circuits to real quantum hardware and collect measurement results. The execution methods may handle provider-specific APIs, authentication, and result formatting.

In one or more embodiments, the quantum computing system 202 may support heterogeneous quantum hardware architectures including but not limited to superconducting transmon qubits, trapped ion systems, neutral atom platforms, photonic quantum processors, silicon quantum dots, nitrogen-vacancy centers in diamond, and topological qubits. Each hardware type may require specific parameter calibration, with energy delta values ω_i adapted to the characteristic energy scales of the platform. For superconducting systems, energy deltas may range from 4-8 GHz; for trapped ions, from 1-100 MHz; for photonic systems, from THz frequencies corresponding to optical transitions.

In one or more embodiments, the parameter calculation and optimization module 104 may implement adaptive one or more quantum backend selection algorithms that evaluate multiple criteria including queue length, error rates, connectivity topology, gate fidelity metrics, coherence times, and cost considerations. The one or more selection algorithms may employ multi-objective optimization techniques such as Pareto frontier analysis, weighted scoring functions, or machine learning-based prediction models. Alternative backend selection strategies may include round-robin scheduling, priority-based allocation, auction mechanisms, or real-time performance monitoring with dynamic failover capabilities.

In one or more embodiments, the quantum computing system 202 may implement quantum hardware abstraction layers that translate generic quantum operations into platform-specific instructions. This abstraction enables seamless migration between different quantum providers without modifying core system logic. The abstraction layer may handle differences in qubit indexing schemes, gate sets, error correction protocols, and measurement procedures. Alternative implementations may include quantum assembly language translators, hardware-agnostic quantum circuit representations, or cloud-based quantum computing orchestration services. A ‘quantum hardware abstraction layer’ may be a software interface that may translate generic quantum circuit representations into hardware-specific instructions for different quantum platforms, enabling interoperability and portability.

In one or more embodiments, the parameter calculation and optimization module 104 may implement one or more backend selection algorithms choosing optimal quantum providers based on criteria comprising queue length, hardware availability, cost considerations, and performance requirements.

In one or more embodiments, the parameter calculation and optimization module 104 may implement fallback mechanisms enabling graceful degradation when primary quantum backends become unavailable. The fallback mechanisms may maintain system availability while preserving security properties.

In one or more embodiments, the parameter calculation and optimization module 104 may implement load balancing across one or more quantum backends to optimize resource utilization and minimize processing delays. The load balancing may consider one or more factors comprising real-time capacity and performance metrics.

In one or more embodiments, the parameter calculation and optimization module 104 may implement topology-aware, quantum-speed-limit-normalized scheduling for multi-backend quantum circuit execution. The processor 406 may obtain a set of quantum circuits, denoted as C_j for j ranging from 1 to J, from memory 404, storage component 402, or user input via input component 414. The available quantum computing system backends may be denoted as b_1, b_2, up to b_B, with each circuit C_j characterized by the number of single-qubit gates N_1q,j, the number of two-qubit CNOT gates N_CX,j, and a connectivity graph G_j. Each backend b may be described by a queue delay Q_b, obtained from provider status APIs, and per-gate durations t_1q,b and t_CX,b, retrieved from hardware specifications stored in memory 404 or storage component 402. Qubit resonance frequencies for backend b may be represented as f_i,b in hertz (Hz), obtained from calibration data. The connectivity map G_b may be retrieved from hardware topology information. For each circuit C_j and candidate backend b, the parameter calculation and optimization module 104 may compute total gate count N_j equal to N_1q,j plus N_CX,j, median qubit frequency f_med,b equal to the median of f_i,b, estimated energy variance sigma_e,j,b equal to pᵢ times f_med,b times the square root of Nj, quantum-speed-limit time t_QSL,j,b equal to pᵢ divided by twice sigma_e,j,b, estimated execution time T_exec,j,b equal to N_1q,j times t_1q,b plus N_CX,j times t_CX,b, and QSL-normalized cost Costjb equal to the sum of Q_b and T_exec,j,b, divided by t_QSL,j,b, multiplied by one plus gamma times d_avg,j, where d_avg,j represents the connectivity penalty and gamma represents a weighting factor that may be configured in memory 404 or storage component 402. Here, d_avg,j denotes the average shortest-path length between pairs of logical qubits in circuit C_j when mapped to the connectivity graph G_b of backend b. This metric penalizes circuit-hardware assignments that require more multi-hop routing, reflecting increased likelihood of swap operations and fidelity loss.

In one or more embodiments, the parameter calculation and optimization module 104 may enhance cost metrics by incorporating gate-error penalties P_f,j,b, defined as the sum over all gates g in circuit C_j of one minus the fidelity F_g,b, where F_g,b represents the fidelity of gate g on backend b, obtained from calibration data stored in memory 404 or storage component 402 or retrieved from provider APIs through communications interface 408. The extended quantum-speed-limit-normalized cost may be computed as Cost_j,b equal to the sum of Q_b, T_exec,j,b, and lambda times P_f,j,b, divided by t_QSL,j,b, multiplied by one plus gamma times d_avg,j, where lambda represents a weighting constant configured through input component 414. The processor 406 may rank backends in ascending order by Cost_j,b and assign each circuit to the backend with minimal cost, implementing platform-specific rescheduling constraints for superconducting, trapped-ion, spin qubit, and photonic platforms based on hardware type information stored in memory 404 or storage component 402. Here, the parameter λ denotes the gate-error penalty weight for cost calculation, and γ denotes the connectivity penalty weighting factor. These are independent from other parameters (such as λ_layer, the layer multiplier in the envelope protection mechanism, and γ_decay, the decay factor).

In one or more embodiments, the measurement analysis and feedback module 108 may implement multi-modal power-spectral-density decomposition for comprehensive energy-variance estimation. The processor 406 may obtain observed power spectral density (PSD) data pairs, denoted as f_k and P_obs(f_k) for k ranging from 1 to N, from input component 414 via sensor measurements or from memory 404 or storage component 402 containing pre-recorded calibration data. The frequency f_k is measured in hertz (Hz), and the PSD value P_obs(f_k) is measured in units of voltage squared per hertz (V²/Hz) or other appropriate power units depending on the quantum hardware platform. The parameter calculation and optimization module 104 may define a composite PSD model incorporating several noise sources: one-over-f noise with amplitude A_1f in V²/Hz, white noise with amplitude A_white in V²/Hz, telegraph noise with amplitude A_tel in V²/Hz and corner frequency f_tel in hertz, and coherent resonance with amplitude A_coh in V²/Hz, center frequency f_coh in hertz, and width sigma_f in hertz. The model is given by P_model(f_k) equal to A_1f divided by one plus f_k, plus A_white, plus A_tel divided by one plus the square of the ratio f_k to f_tel, plus A_coh multiplied by the exponential of negative one-half times the square of the ratio of f_k minus f_coh to sigma_f. All parameters are initially configured through input component 414.

In one or more embodiments, the parameter calculation and optimization module 104 may invoke constrained least-squares solvers stored in memory 404 or storage component 402 to minimize the sum over k of the squared differences between P_obs(f_k) and P_model(f_k) with respect to the parameter vector p equal to [A_1f, A_white, A_tel, f_tel, A_coh, f_coh, sigma_f], subject to bounds such that zero is less than or equal to each amplitude parameter and each is less than or equal to a maximum value A_max, and such that f_tel and f_coh are within the range from f_min to f_max, where all bounds are configured in memory 404 or storage component 402. When fitting libraries are unavailable, the processor 406 may implement gradient descent by defining an error function E(p) as the sum over k of the squared differences between P_obs(f_k) and P_model(f_k; p), and iteratively updating the parameter vector p by subtracting the learning rate eta times the gradient of E with respect to p, where eta is configured through input component 414. The measurement analysis and feedback module 108 may compute energy-variance contributions for each gate family g as the sum over k of w_g times f_k squared times P_model(f k), where w_g is a gate-specific weighting factor stored in memory 404 or storage component 402. The composite energy variance sigma_E is defined as the square root of the sum over g of the squared energy-variance contributions.

In one or more embodiments, the parameter calculation and optimization module 104 may implement quantum control pulse compression with enhanced leakage guard protection. The processor 406 may obtain an input list of rotation angles theta_i, for i from 1 to n, measured in radians from memory 404 or storage component 402 or user input via input component 414, and a leakage tolerance tau greater than zero, typically set between 0.01 and 0.1, configured through input component 414. The parameter calculation and optimization module 104 may compute the total magnitude T as the sum over i of the absolute value of theta_i, and the scaling ratio r as pᵢ divided by T. For scaled angles theta_i_scaled equal to r times theta_i, the processor 406 may compute the new total magnitude T_scaled as the sum over i of the absolute value of theta_i_scaled and the leakage deviation delta as the absolute value of T_scaled minus pᵢ, divided by pᵢ. When delta exceeds tau, the processor 406 may compute a corrective angle theta_corr equal to the sign of the final theta_i_scaled times the difference between pᵢ and T_scaled. For each final rotation angle, the processor 406 may compute the pulse duration delta_t_i as pᵢ divided by twice the composite energy variance sigma_E, where sigma_E is obtained from quantum hardware calibration data. The processor 406 may generate shaped pulse envelopes, which may be selected from Gaussian, DRAG, Blackman, Slepian, or tan-sine profiles stored in storage component 402, ensuring that the product of sigma_E and delta_t_i is equal to pᵢ divided by two within tolerance tau.

In one or more embodiments, the parameter calculation and optimization module 104 may extend leakage guard protection to multi-qubit rotations implementing exp(−i θᵢⱼ σ_z\hat{ }i⊗σ_z\hat{ }j) operations. The parameter calculation and optimization module 104 may compute combined variance σ_E,ij using PSD analysis results that stored in memory 404 and/or storage component 402 and set pulse duration Δtᵢⱼ=π/(2 σ_E,ij). When Σ_(i,j)|θij| ≠π, the processor 406 may compute corrective rotation θ_corr on one qubit such that total rotation magnitude equals π, implementing multi-qubit leakage guard protection across coupled qubit pairs identified from coupling map information that may be retrieved from quantum computing device 112 via exchange interface 118.

In one or more embodiments, the measurement analysis and feedback module 108 may implement leakage-aware readout optimization for enhanced measurement fidelity. The processor 406 may obtain readout rotation angle θ_read=π from configuration parameters that may be stored in memory 404 and/or storage component 402, set of idle extension counts { [symbol] ᵢ|i=1, . . . , L} where [symbol] ᵢ ∈N typically ranging from 0 to 100 as may be configured through input component 414, qubit energy variance σ_E measured in appropriate units (typically rad/s) from calibration data that may be stored in storage memory 404 and/or storage component 402, and fixed identity gate duration t_id that may be obtained from hardware specifications of quantum computing device 112 via exchange interface 118. For each [symbol] ᵢ, the measurement analysis and feedback module 108 may generate leakage-aware readout circuit comprising application of rotation Rz(θ_read) where θ_read=π, application of [symbol] ᵢ successive identity gates each with duration t_id, application of Hadamard gate H, and measurement in Z basis. The quantum computing device 112 may apply Rz(π) via pulse duration t_pulse=π/(2×σ_E), apply [symbol] ᵢ idle pulses of duration t_id, apply Hadamard gate H, measure qubit Q₀, and return counts {N_{0,i}, N_{1,i}} to the measurement analysis and feedback module 108 via exchange interface 118. The processor 406 may determine optimal idle extension [symbol] _opt such that σ_E×( [symbol] _opt×t_id)≈π/2, maximizing measurement contrast while minimizing leakage or under-driven readout errors.

In one or more embodiments, the measurement analysis and feedback module 108 may extend leakage-aware readout to simultaneous multi-qubit measurements by generating circuits comprising application of Rz(π)⊗I\hat{ }⊗(m−1) to the first qubit, application of [symbol] ᵢ successive identity gates on all qubits, application of Hadamard gates H\hat{ }⊗m, and measurement in Z basis, where m represents the number of qubits obtained from circuit topology that may be stored in memory 404 and/or storage component 402. The processor 406 may compute joint counts (N_{0 . . . 0}, N_{0 . . . 1}, . . . , N_{1 . . . 1}) from measurement results that may be received via exchange interface 118 and derive multi-qubit leakage probability, with optimal idle extension satisfying σ_E\hat{ }(i) ( [symbol] _opt t_id)≈π/2 for each qubit i. The measurement analysis and feedback module 108 may implement tomographic leakage estimation by rotating qubits into X or Y basis via H or S†H gates, defining tomographic leakage metric L_tomo incorporating all basis measurements, with results that may be stored in memory 404 and/or storage component 402 for subsequent analysis.

In one or more embodiments, the error correction manager 106 may implement time-energy-constrained scheduling of quantum error correction operations. The processor 406 may obtain a list of logical-ancilla stabilizer checks indexed by j=1, . . . , M from error correction protocols that may be stored in memory 404 and/or storage component 402, each with required energy variance σ_E,req,j, corresponding physical qubit variances {σ_E,phys,i} obtained from calibration data that may be stored in memory 404 and/or storage component 402, and base cycle time t_cycle configured through input component 414. For each stabilizer check j, the processor 406 may identify corresponding physical qubit i from qubit mapping information that may be stored in memory 404 and/or storage component 402, compute minimal required check time Δt_j,min=π/(2×σ_E,phys,i), and determine idle-extension time t_idle,j=max{0, Δt_j,min−t_cycle}. The error correction manager 106 may construct QEC schedules with time intervals [t_start,j, t_start,j+t_cycle+t_idle,j], detect conflicts between stabilizers sharing physical resources based on hardware topology information from quantum computing device 112, insert conflict-resolution delays Δt_swap, and extend scheduling to concatenated code levels k=2, . . . , K using recursive application of Mandelstam-Tamm constraints.

In one or more embodiments, the error correction manager 106 may adapt scheduling for surface codes and color codes by treating each syndrome measurement as multi-qubit parity check. For syndrome measurement j involving qubits {Q_i1, . . . , Q_ik} identified from code structure stored in memory 404 and/or storage component 402, the processor 406 may compute σ_E,phys\hat{ }(i) for each data and ancilla qubit from calibration data that may be stored in memory 404 and/or storage component 402, derive Δt_j,min=π/(2 max_i σ_E,phys\hat{ }(i)) ensuring all qubits satisfy Mandelstam-Tamm constraints. For lattice surgery operations, the processor 406 may insert merge or split idle intervals Δt_merge ensuring σ_E Δt_merge≈π/2. When stabilizer checks fail due to insufficient σ_E,phys\hat{ }(i) (σ_E t<π/2), the processor 406 may adaptively insert corrective echo pulses or dynamic decoupling sequences for affected qubits, with pulse sequences retrieved from storage component 402.

In one or more embodiments, the verification module 122 may implement tenant isolation and energy-time accounting for multi-tenant quantum cloud environments. The processor 406 may obtain tenant job submissions {Jᵢ|i=1, . . . , T} from user devices 206 via communications interface 408, where each job Jᵢ includes quantum circuit Cᵢ and tenant identifier ID_tenant,i, assigning each tenant initial energy-time quota Q_tenant\hat{ }(0) that may be configured through input component 414 or retrieved from memory 404 and/or storage component 402. For hierarchical tenant quotas, the processor 406 may group tenants into organizations O [symbol] based on organizational data that may be stored in memory 404 and/or storage component 402 and assign organizational quotas Q_O [symbol] \hat{ }(0). The feedback control module 110 may compute, for each gate g∈Cᵢ, energy variance σ_E,g from calibration data that may be stored in memory 404 and nominal pulse duration t_pulse,g=π/(2×σ_E,g) for rotations saturating Mandelstam-Tamm bound. The estimated energy-time consumption may be ΔQ_est,i=Σ_g∈Ci [σ_E,g×t_pulse,g]. The processor 406 may compare ΔQ_est,i to tenant's remaining quota that may be retrieved from memory 404 and/or storage component 402, approve or reject jobs based on available quota, schedule approved jobs, retrieve actual execution metrics from quantum computing device 112 via exchange interface 118, compute actual energy-time consumption ΔQ_act,i, update tenant quotas that may be stored in memory 404 and/or storage component 402, and append cryptographically secure ledger entries containing (Jᵢ, ID_tenant,i, ΔQ_act,i, timestamp, digital signature) to the blockchain or distributed ledger.

In one or more embodiments, the error correction manager 106 may implement alternative ledger systems including but not limited to public blockchain (Ethereum), permissioned Hyperledger fabric, or append-only Merkle trees, with configuration parameters that may be stored in memory 404 and/or storage component 402. Each entry (Jᵢ, ID_tenant,i, ΔQ_act,i, timestamp, signature) may be hashed using hash functions or configurable cryptographic hash (default SHA-3-256, alternative SHA-512/256, BLAKE3, etc.) and signed using ECDSA, Ed25519, or quantum-safe signatures implemented by security module 126. The processor 406 may implement token-on-chain approaches where each ΔQ_est,i burns tokens from tenant's on-chain balance that may be retrieved through communications interface 408. When job Jᵢ ∈O [symbol] is submitted, the processor 406 may deduct first from Q_O [symbol] that may be stored in storage memory 404 and/or storage component 402, then from Q_tenant,i, issuing surcharges to all tenants in O [symbol] when Q_O [symbol] becomes negative, with billing information processed through transaction assembly module 120.

In one or more embodiments, the quantum computing system may implement platform-specific adaptations for diverse quantum hardware architectures. For superconducting qubit implementations, rotation operations Rz(θ) may correspond to virtual Z rotations via frame updates or shaped microwave pulses with duration t_pulse,i=π/(2σ_E,i), controlled-NOT operations may implement cross-resonance or iSWAP-based coupling, and identity gates may correspond to idle delays with active decoupling sequences, where pulse specifications may be stored in memory 404 and/or storage component 402. For trapped-ion implementations, the processor 406 may define Δⱼ=Ω_Rabi,j where Ω_Rabi,j represents carrier Rabi frequency obtained from laser calibration data that may be stored in memory 404 and/or storage component 402, using sideband spectroscopy to estimate σ_E,j. For spin qubit implementations, the processor 406 may define Δⱼ=g μ_B Bⱼ, where g represents g-factor, μ_B represents Bohr magneton, and Bⱼ represents local magnetic field measured by input component 414. For photonic implementations, the processor 406 may define Δⱼ=ω_cavity,j where ω_cavity,j represents cavity resonance frequency that may be obtained from hardware specifications stored in memory 404 and/or storage component 402.

In one or more embodiments, the parameter calculation and optimization module 104 may implement one or more adaptive quantum backend selection algorithms evaluating multiple criteria including queue length, error rates, connectivity topology, gate fidelity metrics, coherence times, and cost considerations, with evaluation criteria that may be configured through input component 414 and historical performance data that may be stored in memory 404 and/or storage component 402. The one or more selection algorithms may employ multi-objective optimization techniques such as Pareto frontier analysis, weighted scoring functions, or machine learning-based prediction models implemented by processor 406. The quantum computing system may implement one or more quantum hardware abstraction layers translating generic quantum operations into platform-specific instructions, handling differences in qubit indexing schemes, gate sets, error correction protocols, and measurement procedures while enabling seamless migration between different quantum providers without modifying core system logic, with abstraction layer configurations that may be stored in memory 404 and/or storage component 402.

In one or more embodiments, the parameter calculation and optimization module 104 may compute alternative quantum speed-limit (QSL) bounds that are experimentally testable on quantum computing device 112. These bounds may serve as complementary or fallback constraints when Mandelstam-Tamm (MT) bounds are not directly applicable due to system noise, limited coherence time, or circuit-specific calibration conditions, with bound selection criteria that may be configured in memory 404 and/or storage component 402. The processor 406 may implement the following testable QSL bounds: Margolus-Levitin (ML) Bound where the processor 406 may compute the average energy Ē_j=|Δ_j| for a two-level system with Hamiltonian energy gap Δ_j obtained from calibration data that may be stored in memory 404 and/or storage component 402, derive the ML time τ_ML,j=π/(2 Ē_j), and verify this limit by evolving a quantum state under calibrated rotations such as R_z(Δ_j·t) and measuring orthogonalization at τ_ML,j via overlap estimation; Bhatia-Davis Bound on Energy Variance where the processor 406 computes an upper bound on energy variance as Var(E)≤(E_max−Ē)(Ē−E_min) using minimum and maximum eigenenergies that may be obtained from hardware characterization data that may be stored in memory 404; Quantum Fisher Information (QFI)-Based Bound where the processor 406 may estimate quantum Fisher information F_Q by constructing parameterized circuits U(θ) and measuring observable sensitivity, with QSL time computed as τ_QFI=1/ΔF_Q; State-Fidelity-Based Orthogonalization Bound where the verification module 122 may track fidelity F(t)=| [symbol] ψ_0|ψ(t) [symbol] |² to determine minimum time τ_fid for F(t)<ε; and Trace Distance-Based Bound where the processor 406 may estimate trace distance D(ρ_0, ρ_t) using tomographic reconstruction data stored in memory 404 and/or storage component 402. Each bound may be selected adaptively based on evolution type, backend calibration data, and circuit structure, with the processor 406 computing multiple bounds in parallel and triggering performance alerts when violations are detected.

In one or more embodiments, the Margolus-Levitin bound verification may employ the calculation of the average quantum energy per qubit, determined according to the system's physical energy model and referenced above the ground state. The quantum Fisher information analysis may utilize the relationship between the Fisher information and energy uncertainty to bound the achievable measurement precision. The verification procedure may cross-validate alternative quantum speed limit formulations, including but not limited to the Margolus-Levitin and Mandelstam-Tamm constraints, to ensure consistent enforcement of minimum evolution time requirements across all theoretical frameworks considered by the system.

In one or more embodiments, when quantum computing device 112 comprises superconducting transmon qubits, the control devices 114 may implement virtual Z-rotations in the microwave control frame by adjusting phase references without physical pulse application. Alternatively, the control devices 114 may implement physical Z-rotations using calibrated microwave pulses with durations and amplitudes determined by error correction manager 106. The control devices 114 may enforce timing resolution constraints √(Σⱼ₌₁ⁿ (Δ′ⱼ)²) δt<10⁻⁶ where δₜ represents the timing uncertainty in pulse application.

In one or more embodiments, when quantum computing device 112 comprises trapped-ion qubits, the control devices 114 may implement single-qubit rotations using individually addressed laser systems. The control devices 114 may generate AC Stark shifts to implement phase rotations R_z(θⱼ) by applying off-resonant laser pulses with intensity and duration parameters determined by error correction manager 106. The control devices 114 may implement state initialization through optical pumping and measurement through state-dependent fluorescence detection.

In one or more embodiments, the quantum computing device 112 may support additional architectures including spin qubits in silicon with electrical control via gate voltages, photonic qubits with linear optical circuits and photon detection, or neutral atom arrays with optical lattice control and Rydberg interactions. The control devices 114 may adapt gate implementations and timing constraints according to the specific hardware architecture while maintaining compatibility with the authentication protocols implemented by classical computing device 102.

In one or more embodiments, the quantum computing system 202 may implement one or more cross-chain quantum verification mechanisms enabling quantum security across multiple blockchain networks through one or more interoperability protocols. The transaction assembly module 120 may support cross-chain implementation utilizing bridge protocols, atomic swap mechanisms, or interoperability frameworks that enable quantum proof validation across different blockchain architectures including public blockchains, permissionless networks, consortium ledgers, and private blockchain implementations.

In one or more embodiments, the verification module 122 may implement cross-chain verification protocols by adapting consensus mechanisms, transaction formats, and verification requirements based on specific blockchain characteristics. The cross-chain adaptation may be configured through protocol parameters that may be stored in memory 404 and/or storage component 402 including but not limited to target blockchain identifiers, consensus mechanism types (e.g., proof-of-stake, Byzantine fault-tolerant), transaction format specifications, and verification threshold requirements. The parameter calculation and optimization module 104 may generate blockchain-specific quantum circuit parameters that maintain security properties across different distributed ledger architectures.

In one or more embodiments, the off-chain storage module 124 may implement one or more cross-chain data synchronization mechanisms for quantum proof propagation and verification across multiple blockchain networks. The synchronization process may utilize cryptographic merkle proofs, cross-chain message passing protocols, or distributed hash table mechanisms to ensure quantum proof availability and integrity across heterogeneous blockchain environments. The verification module 122 may coordinate cross-chain consensus by aggregating quantum proof validation results from multiple blockchain networks, implementing threshold-based acceptance criteria that may require quantum proof validation from a predetermined number of participating blockchain networks.

In one or more embodiments, the parameter calculation and optimization module 104 may implement one or more circuit optimization frameworks comprising gate merging, depth reduction, and resource allocation strategies. The gate merging process may identify compatible quantum operations according to M(G)={g′ᵢ}=F({gⱼ}), where M represents merging functions, G represents original gate sets, g′ᵢ represents merged gates, and F represents compatibility analysis functions. Gate compatibility may be evaluated through C(g₁, g₂)=|U₁U₂−U_merged|, where C represents compatibility metrics, U₁ and U₂ represent individual gate unitaries, and U_merged represents combined operations with thresholds F merge ranging from 10⁻⁶ to 10⁻⁴.

The processor 406 may implement multi-objective optimization minimizing L(C)=α·(1−F(C))+β·D(C)+γ·R(C), where L represents loss functions, F(C) represents circuit fidelity, D(C) represents circuit depth, R(C) represents resource utilization, and α, β, γ represent weighting factors with a ranging from 0.5-0.7, β ranging from 0.2-0.3, and γ ranging from 0.1-0.2. The optimization process may implement hardware-specific adaptations through topology mapping M(q_log→q_phys)=argmin(Σ_{i,j}d(i,j)·c(i,j)), where d(i,j) represents physical distances between qubits and c(i,j) represents required connectivity constraints.

In one or more embodiments, the parameter calculation and optimization module 104 may be configured to compute quantum circuit parameters including phase angles derived from cryptographically unpredictable sources associated with transactions or blocks. The parameter calculation and optimization module 104 may implement energy uncertainty calculations using the formula ΔE=√(Σᵢ(hωᵢ)²), where ωᵢ may represent angular frequencies derived from energy deltas obtained during quantum device calibration, and h may represent the reduced Planck constant.

In one or more embodiments, the parameter calculation and optimization module 104 may derive quantum circuit phase angles from cryptographically unpredictable values which may include blockhashes, transaction hashes, random nonces, or cryptographic commitments. The derivation process may utilize configurable cryptographic hash (e.g., default SHA-3-256, alternative SHA-512/256, BLAKE3, etc.), applied to concatenated input values comprising blockhash data and qubit index identifiers.

1. A system for quantum-authenticated digital token generation comprising:
a classical computing device comprising a parameter calculation and optimization module configured to generate quantum circuit parameters including energy delta values and evolution times constrained by quantum mechanical speed limits, and a verification module configured to verify quantum hardware execution through measurement analysis;
a quantum computing device comprising control devices configured to execute quantum circuits and a quantum system configured to perform quantum mechanical operations;
an exchange interface configured to enable communication between the classical computing device and the quantum computing device;
wherein the parameter calculation and optimization module is configured to enforce minimum evolution time constraints based on energy uncertainty calculated from quantum hardware characteristics, and wherein the verification module is configured to verify authenticity of quantum operations by comparing experimental quantum measurement outcomes with theoretical predictions based on the quantum mechanical constraints.

2. A method for generating quantum-authenticated digital tokens comprising:
determining, using a classical computing device, quantum circuit parameters including energy delta values derived from quantum hardware calibration data;
calculating minimum evolution time constraints based on quantum mechanical speed limits using energy uncertainty derived from quantum hardware characteristics;
generating quantum circuits incorporating the calculated parameters and transmitting the circuits to a quantum computing device via an exchange interface;
executing the quantum circuits on the quantum computing device for the calculated minimum evolution time to obtain quantum measurement outcomes;
analyzing the quantum measurement outcomes using the classical computing device to verify compliance with quantum mechanical constraints and authentic quantum hardware execution;
generating a digital token comprising cryptographic binding of the verified quantum measurements with unique token identifiers.

3. The system of claim 1, wherein the parameter calculation and optimization module is configured to calculate energy uncertainty using root-sum-square combination of individual qubit energy contributions derived from angular frequencies of physical qubits.

4. The system of claim 1, wherein the verification module is configured to implement quantum speed limit verification by continuously monitoring that executed evolution time satisfies minimum time requirements within predetermined tolerance ranges.

5. The method of claim 2, further comprising enforcing hardware-specific minimum time constraints based on physical limitations of the quantum computing device, wherein final evolution time represents the maximum of quantum mechanical minimum time and hardware-specific minimum time.

6. The system of claim 1, wherein the verification module is configured to generate quantum hardware passports comprising device-specific calibration data including qubit frequencies, energy delta values, decoherence times, and noise signatures derived from quantum measurement distributions.

7. The system of claim 6, wherein noise signatures are computed using statistical analysis of quantum measurement distributions through cryptographic hashing of histogram data, variance metrics, and correlation matrices.

8. The system of claim 1, wherein the parameter calculation and optimization module is configured to implement device fingerprinting using quantum hardware topology, connectivity constraints, and noise characteristics specific to the quantum computing device.

9. The system of claim 1, wherein the control devices are configured to implement echo revival methods using time-reversed quantum circuits to verify quantum coherence maintenance through state revival probability measurements.

10. The system of claim 9, wherein echo circuits are constructed by applying identical gate sequences in reverse temporal order with negated phase parameters relative to forward evolution sequences.

11. The method of claim 2, further comprising calculating revival probability as ratio of measurements yielding initial quantum states to total measurement shots, and rejecting quantum proofs when revival probability falls below a predetermined threshold.

12. The system of claim 1, wherein the parameter calculation and optimization module is configured to implement temporal anti-precomputation mechanisms by generating cryptographic commitments before quantum circuit parameters are revealed, ensuring temporal separation between commitment recording and parameter availability.

13. The system of claim 1, wherein the parameter calculation and optimization module is configured to generate phase tweaks using hash-based message authentication code operations with master keys, challenge nonces, qubit indices, and token identifiers as inputs.

14. The system of claim 1, wherein the verification module is configured to implement blind challenge generation methods using cryptographically secure master keys inaccessible to quantum execution environments.

15. The system of claim 1, wherein the verification module is configured to implement multi-modal verification comprising quantum state overlap verification, entropy analysis, noise signature verification, timing constraint verification, and hardware attestation verification.

16. The system of claim 15, wherein quantum state overlap verification comprises calculating experimental overlap from measurement counts and theoretical overlap from quantum evolution parameters and comparing within predetermined tolerance ranges.

17. The method of claim 2, further comprising performing entropy analysis and rejecting quantum proofs when entropy falls outside quantum hardware-expected ranges.

18. The system of claim 1, further comprising a transaction assembly module configured to create blockchain transactions incorporating quantum proof data and an off-chain storage module configured to store quantum measurement data using content-addressed storage with cryptographic integrity verification.

19. The system of claim 1, wherein the verification module is configured to coordinate with distributed validator nodes for consensus-based verification of quantum proofs in blockchain networks.

20. The system of claim 1, wherein the quantum computing device comprises quantum hardware selected from the group consisting of superconducting qubits, trapped ion systems, photonic quantum processors, neutral atom platforms, silicon quantum dots, nitrogen-vacancy centers, and topological qubits, and wherein the parameter calculation and optimization module adapts energy delta values and timing constraints to characteristic energy scales of the selected quantum hardware platform.
